(19) United States
(12) Patent Application Publication
(10) Pub. No.: US 2026/0010901 A1
(43) Pub. Date: Jan. 8, 2026

(54) SYSTEMS AND METHODS FOR AUTHENTICATING A USER

(71) Applicant: Capital One Services, LLC, McLean, VA (US)

(72) Inventor: Paul Y. Moreton, Glen Allen, VA (US)

(21) Appl. No.: 18/763,802

(22) Filed: Jul. 3, 2024

(51) Int. Cl. G06Q 20/40; G06Q 20/32; G06Q 20/34

(52) U.S. Cl. CPC G06Q 20/401; G06Q 20/353; G06Q 20/3278

(57) ABSTRACT

Disclosed embodiments may include a method for authenticating a user. The method may include receiving first information at a card network from a mobile device. The mobile device may have received the first information from a smart card. The method may include determining, at the card network, that the first information includes an authentication flag. The method may include authenticating, by the card network, an identity of the user by comparing the first information to second information associated with the user and stored in a database. The method may further include transmitting, from the card network, identity information associated with the first information to the mobile device.

### FIELD

The disclosed technology relates to systems and methods for authenticating a user. Specifically, this disclosed technology relates to utilizing the existing payment processing infrastructure to perform additional functionalities, such as authentication of a user.

### BACKGROUND

Transaction card processing is typically achieved by a merchant communicating a transaction authorization request to an issuer via an acquirer and a card network, and the issuer transmitting a response to the authorization request back through the card network and the acquirer to the merchant. This is a well-established payment processing infrastructure that allows for users to utilize transaction cards (e.g., credit cards) at merchants and obtain real-time authorizations (or denials) from their issuer financial institution to allow the user to complete a purchase at a merchant point-of-sale (POS) device or via a website using, for example, a mobile device.

However, for security reasons, financial institutions may want to authenticate the user prior to authorizing the transaction to avoid fraudulent uses of the transaction card. In such cases, it is common for financial institutions to utilize two-factor authentication to verify the authenticity of the transaction. But, such two-factor authentication commonly requires the user to interact with a separate device (e.g., sending a verification code to a mobile device of the user), which may be inconvenient or may not provide adequate protection in cases in which a fraudulent user has the transaction card number for use in making a purchase and has access to the device being used for the two-factor authentication.

Accordingly, there is a need for other modes of authenticating a user that provide additional security. Other solutions have proposed utilizing specialized transaction card hardware or interfacing that is capable of performing other functionalities in addition to Europay-Mastercard-Visa (EMV) transactions, such as authentication of the user or identity verification, as described for example, in U.S. Pat. No. 10,546,444 titled “Systems and Methods for Secure Read-Only Authentication,” U.S. Pat. No. 10,395,244 titled “Systems and Methods for Providing Card Interactions,” U.S. Pat. No. 10,581,611 titled “Systems and Methods for Cryptographic Authentication of Contactless Cards,” and U.S. Pat. No. 10,664,830 titled “Systems and Methods for Selective Contactless Communication,” the content of each of which are expressly incorporated by reference herein in their entirety. However, inclusion of such specialized transaction card hardware may increase the complexity and cost of manufacturing such cards, as well as requiring more extensive backend or mobile device systems to operate.

Accordingly, there is a need for improved systems and methods for authenticating a user using the existing payment processing infrastructure and/or without the use of dedicated hardware on the transaction card. Embodiments of the present disclosure are directed to this and other considerations.

### SUMMARY

Disclosed embodiments may include a method for authenticating a user. The method may be executed by a system that may include one or more processors, and memory in communication with the one or more processors and storing instructions that, when executed by the one or more processors, are configured to cause the system to authenticate a user. The method may include receiving first information at a card network from a mobile device. The mobile device may have received the first information from a smart card. The method may include determining, at the card network, that the first information includes an authentication flag. The method may include authenticating, by the card network, an identity of the user by comparing the first information to second information associated with the user and stored in a database. The method may further include transmitting, from the card network, identity information associated with the first information to the mobile device.

Disclosed embodiments may include a system for authenticating a user. The method may be executed by a system that may include one or more processors, and memory in communication with the one or more processors and storing instructions that, when executed by the one or more processors, are configured to cause the system to authenticate a user. The method may include receiving first data at a mobile device from a smart card via near field communication (NFC). The first data may be in a Europay-Visa-Mastercard (EMV) format. The method may include generating, from the first data, second data including an authentication flag. The authentication flag may indicate a request for authentication. The method may include transmitting the second data to a card network. The method may further include receiving, from the card network, identity information to authenticate the user.

Disclosed embodiments may include a system for authenticating a user. The method may be executed by a system that may include one or more processors, and memory in communication with the one or more processors and storing instructions that, when executed by the one or more processors, are configured to cause the system to authenticate a user. The method may include receiving first information from a mobile device. The mobile device may have received the first information from a smart card. The method may include determining that the first information includes an authentication flag. The method may include authenticating an identity of the user by comparing the first information to second information associated with the user and stored in a database. The method may further include transmitting identity information associated with the first information to the mobile device.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1A is a flow diagram illustrating an exemplary method for authenticating a user via a card network in accordance with certain embodiments of the disclosed technology.

FIG. 1B is a flow diagram illustrating an exemplary method for authenticating a user via a card network in accordance with certain embodiments of the disclosed technology.

FIG. 2A is a flow diagram illustrating an exemplary method for authenticating a user via an issuer in accordance with certain embodiments of the disclosed technology.

FIG. 2B is a flow diagram illustrating an exemplary method for authenticating a user via an issuer in accordance with certain embodiments of the disclosed technology.

FIG. 3A is block diagram of an example mobile device system 320A used to provide authenticating a user, according to an example implementation of the disclosed technology.

FIG. 3B is block diagram of an example authentication system 320B used to provide authenticating a user, according to an example implementation of the disclosed technology.

FIG. 4 is block diagram of an example system that may be used to provide authenticating a user, according to an example implementation of the disclosed technology.

FIG. 5A is a flow diagram illustrating a method for seeking authorization for a transaction from an issuer.

FIG. 5B is a flow diagram illustrating a method for receiving a transaction authorization or denial from an issuer.

FIG. 6 is a flow diagram illustrating an exemplary method for authenticating a user by a card network in accordance with certain embodiments of the disclosed technology.

FIG. 7 is a flow diagram illustrating an exemplary method for authenticating a user by an issuer in accordance with certain embodiments of the disclosed technology.

FIG. 8 is a flow diagram illustrating an exemplary method for authenticating a user by a card network in accordance with certain embodiments of the disclosed technology.

FIG. 9 is a flow diagram illustrating an exemplary method for authenticating a user by an issuer in accordance with certain embodiments of the disclosed technology.

### DETAILED DESCRIPTION

Examples of the present disclosure related to systems and methods for authenticating a user. More particularly, the disclosed technology relates to utilizing the currently existing payment processing infrastructure (e.g., the present transaction systems associated with Europay-Mastercard-Visa (EMV) transaction technologies) to facilitate additional functionalities using a smart card, such as authentication. The systems and methods described herein utilize, in some instances, graphical user interfaces, which are necessarily rooted in computers and technology. Graphical user interfaces are a computer technology that allows for user interaction with computers through touch, pointing devices, or other means. The present disclosure details presenting a GUI on a mobile device to request a user authentication by tapping a smart card to the mobile device. This, in some examples, may involve using data received from a node of a payment processing system, a third party, a merchant, and/or a smart card to dynamically change the graphical user interface to indicate a request for a user authentication and provide updates on the user authentication process, which involves using, for example, an EMV chip on a smart card and a wireless chip reader on the mobile device. Using a graphical user interface in this way may allow the system to perform user authentications in real-time using a smart card and a mobile device. This is a clear advantage and improvement over prior technologies that perform two-factor authentications without use of the smart card because those systems may allow someone who has access to the user’s mobile device and card number to potentially commit fraudulent transactions. The present disclosure solves this problem by providing authentication in which physical possession of the smart card is needed. Furthermore, the systems and methods described herein improve, in some instances, the operation of computers and technology by allowing user authentication to be performed by merely tapping a smart card to a mobile device in response to an authentication request prompt. Furthermore, in some instances, the disclosed systems and methods allow for user authentications to be performed with a smart card using only conventionally provided EMV data, without requiring any additional applets or specialized hardware on the smart card. Overall, the systems and methods disclosed have significant practical applications in the user authentication field because of the noteworthy improvements of the smart card-based authentication system, which are important to solving present problems with this technology.

Although the present disclosure is generally directed towards describing a user authentication process via tapping a smart card to a mobile device in response to an authentication prompt request presented by the mobile device, it should be understood that other actions may be similarly achieved by tapping the smart card to the mobile device in response to other prompts. For examples, such actions may include one or more of providing second level authentication to an application on a device (e.g., the mobile device or a separate device), providing a user access to an application on a device, launching an application on a device, activating an application on a device, downloading an application to a device, accessing restricted information on a device, making a purchase using an application of a device, making a purchase of a certain value, activating the card for EMV transactions using the device, or any other suitable action where a secondary user authentication may be suitable. Further, although the present disclosure is generally directed towards use of a smart card, the term smart card is not intended to be limiting and is intended to describe a card associated with a user account, the card having electronic components that may store data and wirelessly transmit data to another device, such as a merchant point-of-sale device and/or a mobile device (e.g., a smartphone). As such, a smart card may alternatively be referred to or considered to be a transaction card, a debit card, a credit card, rewards card, or any other type of card associated with an account of a user that includes circuitry/a chip for storing and transmitting account data.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

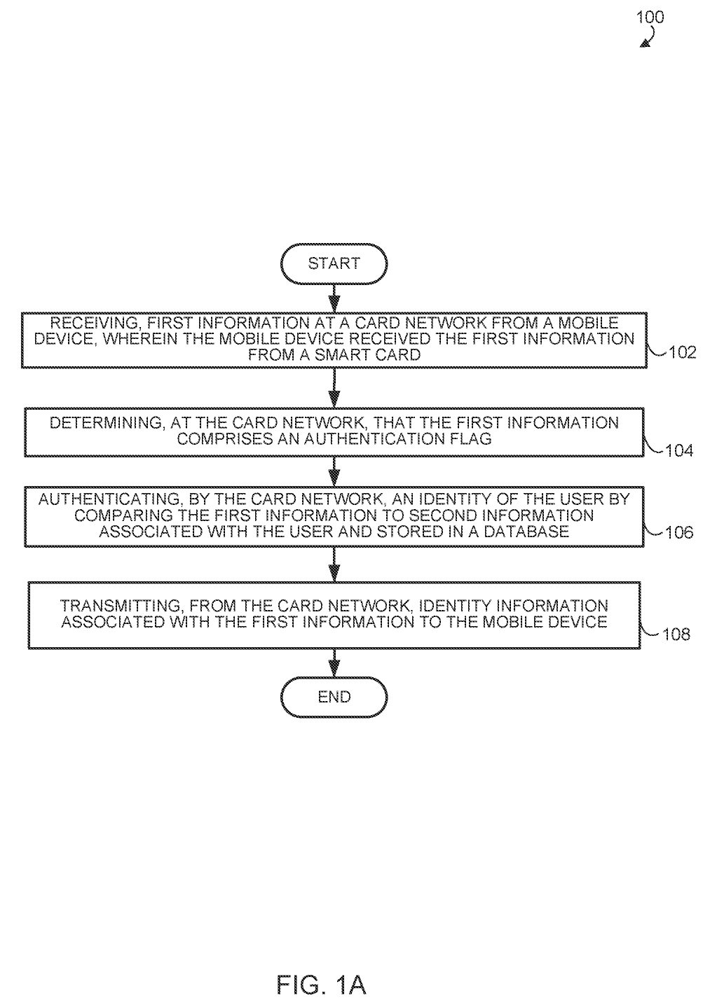

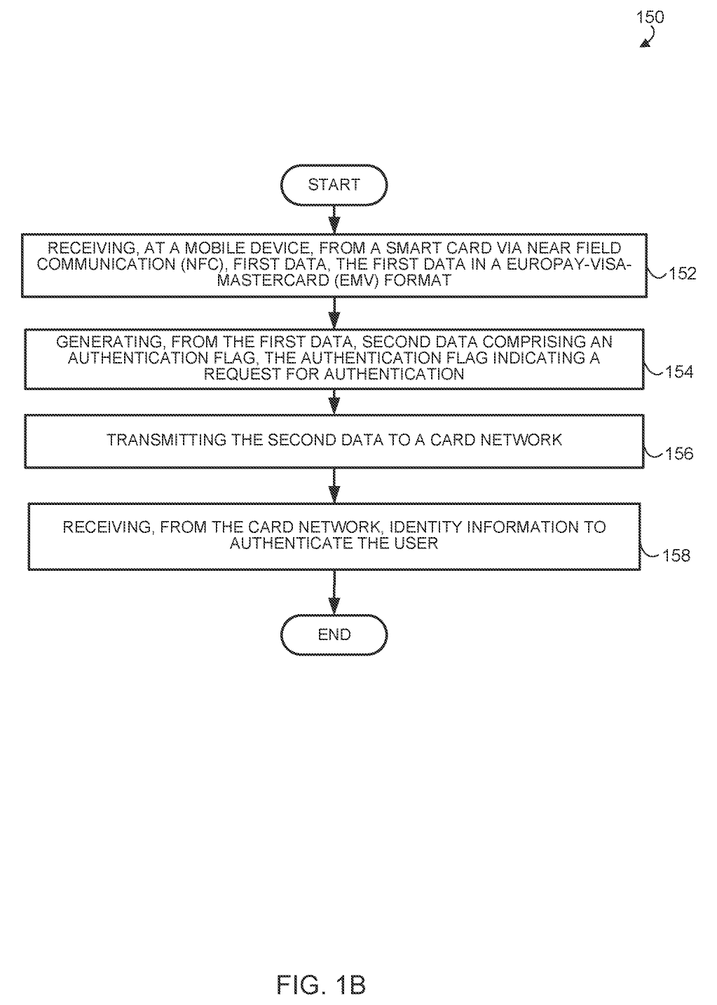

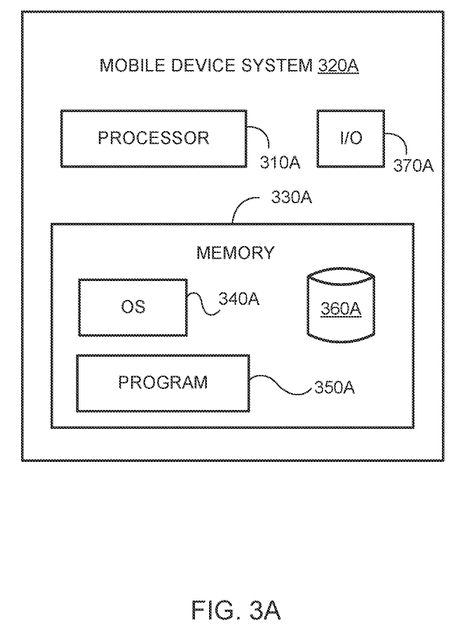

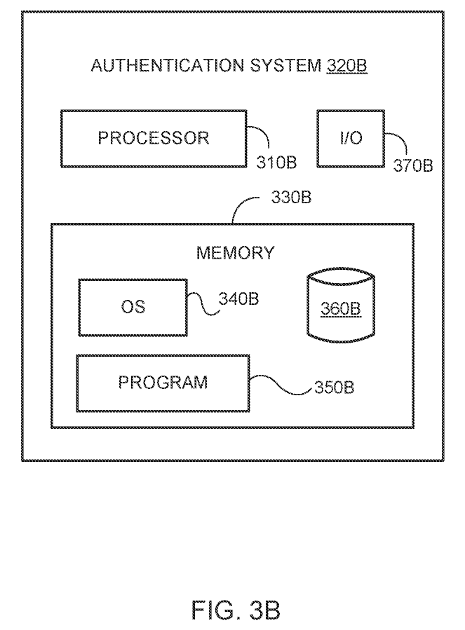

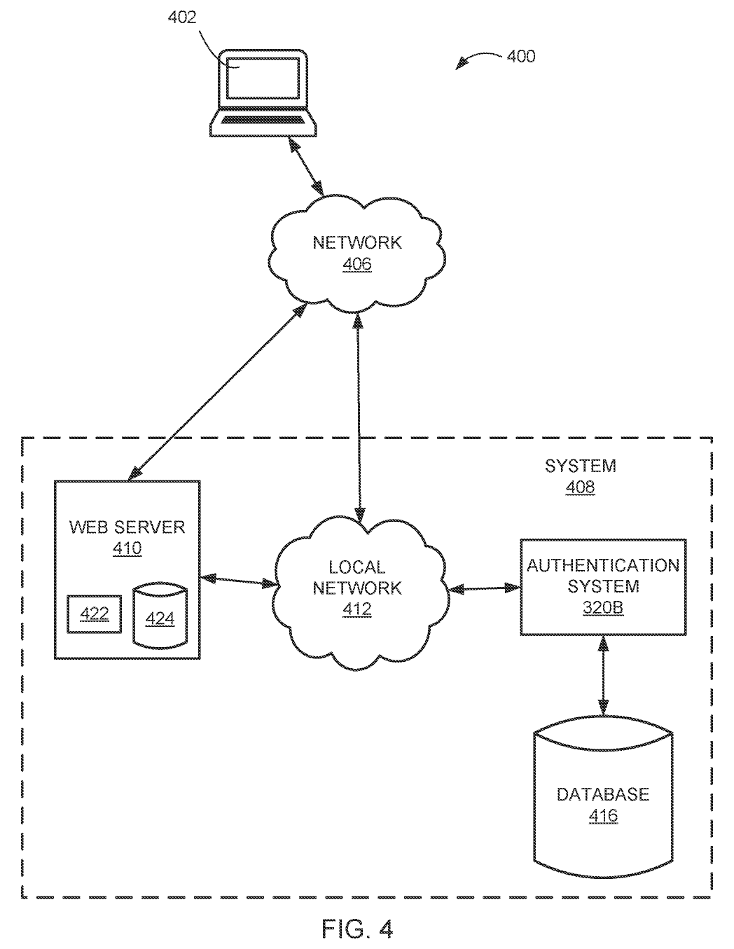

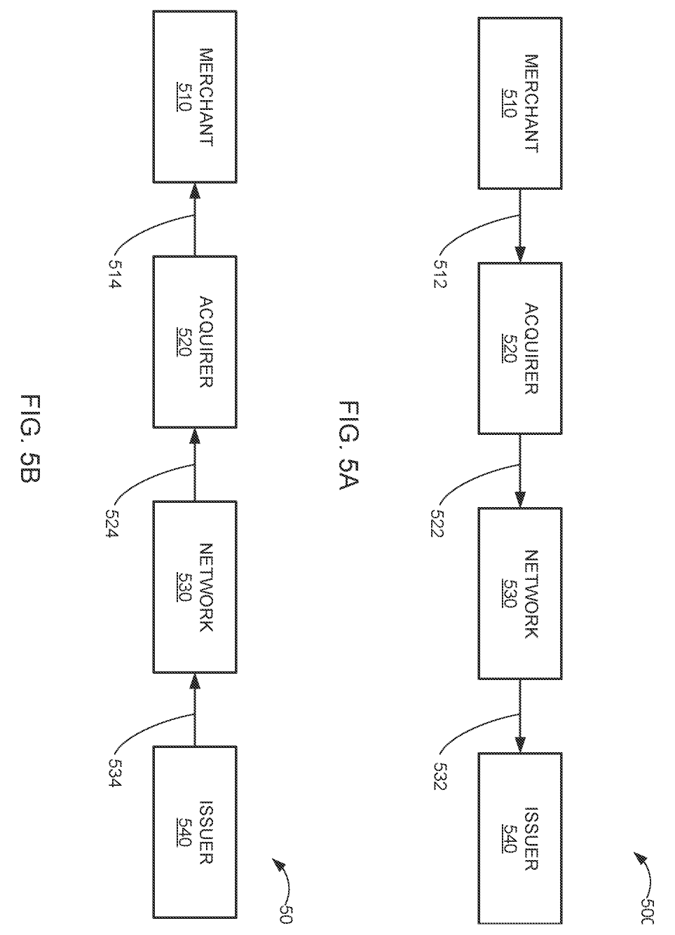

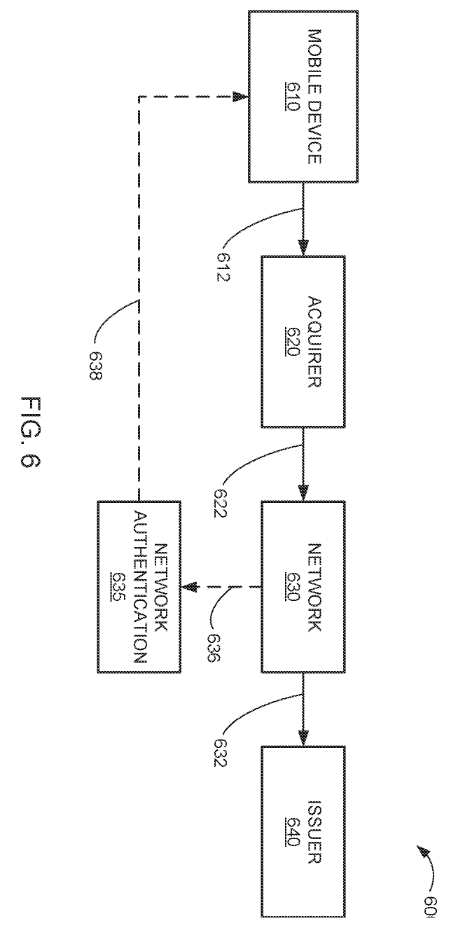

FIG. 1A is a flow diagram illustrating an exemplary method 100 for authenticating a user at a card network, in accordance with certain embodiments of the disclosed technology. The steps of method 100 may be performed by one or more components of the system 400 (e.g., authentication system 320B, or web server 410 of system 408), as described in more detail with respect to FIGS. 3B and 4. Further, elements of the system 400 may be incorporated into acquirer, card network or issuer systems as described with respect to FIGS. 5A-9.

In block 102, the method may include receiving first information at a card network from a mobile device (e.g., via mobile device system 320A). According to some embodiments, the mobile device may have received the first information from a smart card. In some embodiments, the mobile device may receive the first information from the smart card via near field communication (NFC). According to some embodiments, the first information may be in a Europay-Visa-Mastercard (EMV) format. As will be understood by those of skill in the art, data in an EMV format (which may also be referred to as “EMV data”) may include account information, such as a PAN number. In some embodiments the PAN number may be encrypted in a cryptogram. EMV data may also include information about the user, or information specific to the user.

In some embodiments, the first information may include information that was generated by an EMV applet on the smart card. An applet may be a small computer program that performs a specific task. An EMV applet may be used to perform communication and computation and may be used to perform transactions. As will be appreciated by those of skill in the art, a smart card may include electronic circuitry or an electronic chip capable of storing and wirelessly transmitting (e.g., via NFC) information to a device such as mobile device system 320A. In some embodiments, the smart card may exclusively transmit information to the mobile device via the EMV applet. In some embodiments, the smart card may not have additional applets besides those used for EMV. In some embodiments, the applets on the smart card used to transmit data to the mobile device may be used for EMV transactions. In some embodiments, the smart card may be a typical card used for EMV transactions.

According to some embodiments, the first information, which may be typical EMV data, may be transmitted to the card network from the mobile device via an acquirer and the acquirer may determine the card network from a plurality of card networks. As will be understood by those of skill in the art, the acquirer may select a card network from a plurality of card networks based on the first information. For example, in some embodiments, the acquirer may identify an identifier or at least a portion of primary account number (PAN) in the first information and select a card network that is associated with the identifier or at least the portion of the PAN.

In some embodiments, the first information may include or be included in a zero-amount authorization. In other words, in some embodiments, the mobile device may generate transaction data that includes the first information and the transaction data may include a value of “$0.00” in a field that designates the value of a transaction that is being sought to be authorized. In some embodiments, the zero-amount authorization may be a credit card verification (e.g., a credit card authorization, for example placed at a hotel or gas station when a card is first used to verify the card is capable of being charged). Furthermore, in some embodiments, the mobile device may include an authentication flag in the transaction data that may indicate a request for a user authentication. According to some embodiments, the transaction data that includes the first information may be transmitted by the mobile device to an acquirer, which may forward the transaction data to the card network.

In block 104, the method may include determining that the first information comprises an authentication flag. In some embodiments, this determination may be made at the card network. For example, in some embodiments, the card network may be configured to analyze the first information and identify one or more particular flags contained within the first information, such as a particular value stored in a particular location in a data structure of the information or a particular prefix or suffix appended to a particular portion of the information.

According to some embodiments, the authentication flag may prevent the first information from being transmitted to an issuer. In other words, the authentication flag may represent a request to perform a user authentication while simultaneously providing an indication that the transaction data provided is not for a real purchase transaction, and thus indicating the normal transaction authorization request process associated with a typical transaction should be abandoned, such that the card network does not forward the received transaction data to the issuer.

In some embodiments, the authentication flag may include a name, name prefix, name suffix or combinations thereof. For example, in some embodiments where the authentication flag is a name, the card network may detect that a specific merchant name is an authentication flag (e.g., CAPITALONEAUTHENTICATION). In an example when the card is used, the card network may analyze various merchant names associated with transactions that come through the network related to the card, such as STARBUCKS RICHMOND, HILTON DOWNTOWN, and CAPITALONEAUTHENTICATION. Accordingly, in this example, the card network would recognize that STARBUCKS RICHMOND and HILTON DOWNTOWN are normal merchant transactions on the card, however, CAPITALONEAUTHENTICATION is recognized as an authentication flag. Therefore, the card network processes CAPITALONEAUTHENTICATION differently from other merchant transactions because of the name.

In some embodiments, the authentication flag may be a name prefix or name suffix (e.g., a series of digits, letters or symbols, such as ***AUTH***, may be appended to the beginning or end of merchant name to indicate that the transaction data contains an authentication flag. For example, in some embodiments, transactions being authorized by the card network could comprise a financial authorization and an authentication (e.g., ***AUTH***VRBO or VRBO***AUTH***). The card network may be capable of recognizing that the transaction authorization to VRBO also contains an authentication request in response to detecting the authentication flag.

In some embodiments, the authentication flag may be a modification of the name of the merchant as described in the EMV transaction data of the transaction card. In some embodiments, the authentication flag may be a unique value within the EMV transaction data (e.g., aut_flag value = 0 or aut_flag value = 1, where 0 would indicate that the present transaction data does not contain an authentication request and 1 would indicate that the present transaction data contains an authentication request).

In block 106, the method may include authenticating, by the card network, an identity of the user by comparing the first information to second information associated with the user and stored in a database. In some embodiments, the card network may alternatively forward the first information to an authentication system (e.g., authentication system 320B) that performs the authentication. According to some embodiments, performing the authentication may include for example, identifying a PAN number in the first information, performing a lookup in a stored table of PAN numbers in the second information and identifying corresponding identity information (e.g., user information and/or device/communication information) stored in the table in association with the PAN.

In block 108, the method may include transmitting identity information associated with the first information from the card network to the mobile device (e.g., mobile device system 320A). In some embodiments, the identity information transmitted from the card network to the mobile device may comprise actual identity information that may be used by the mobile device to identify the user. In some embodiments, the identity information transmitted from the card network to the mobile device may be an indication that the information received at the card network is verified against corresponding second information stored by the card network.

In some embodiments, the identity information is not transmitted to the mobile device via the acquirer. For example, in some embodiments, the identity information may be transmitted from the card network to the mobile device directly, for example, via a network connection such as an Internet connection, cellular network connection or the like.

According to some embodiments, the second information associated with the user may include communication information and the card network may transmit the identity information to a mobile application on the mobile device using the communication information. For example, the communication information may include information sufficient to identify the mobile device (e.g., a phone number, serial number, or other identification number associated with the mobile device) or an instance of the mobile application (e.g., an identification number of the instance of the mobile application running on the mobile device) that may allow the card network to directly communicate with the mobile device, for example, via a network such as the Internet.

According to some embodiments, the mobile device may receive the identity information and complete the user authentication by, for example, comparing the received identity information to stored identity information associated with the user to determine whether they match. If the two sets of identity information match, the mobile device may determine that the user has been successfully authenticated.

FIG. 1B is a flow diagram illustrating an exemplary method 150 for authenticating a user via a card network, in accordance with certain embodiments of the disclosed technology. The steps of method 200 may be performed by the mobile device system 320A, as described in more detail with respect to FIG. 3A.

In block 152, the method may include receiving first data at a mobile device (e.g., via mobile device system 320A). According to some embodiments, the first data may be received from a smart card via near field communication (NFC). For example, in some embodiments, a mobile application running on the mobile device may prompt the user via a GUI to tap a smart card to the mobile device (e.g., to perform a requested user authentication using the smart card) so that the smart card may wirelessly communicate card data to the mobile device (e.g., via a wireless reader of the mobile device). Furthermore, the first data may be in a Europay-Visa-Mastercard (EMV) format. According to some embodiments, the first data may be generated by an EMV applet on the smart card. The first data may be conventional EMV data.

According to some embodiments, the method 150 may further include receiving an action requiring authentication from the user via a first graphical user interface on a mobile application on the mobile device (e.g., the user requests to make a purchase above a defined limit, access secured storage, or access an area of an application requiring multi-factor authentication), generating, at the mobile device, a second graphical user interface requesting the user locate the smart card near the mobile device, and displaying the second graphical user interface on a display of the mobile device. The mobile application may cause the mobile device to be in a state ready to receive (e.g., via NFC) information from the smart card in response to, for example, the user tapping the smart card to a reader of the mobile device. In some embodiments, an action requiring authentication may be provided to the mobile application in response to an attempted purchase by the user. In some embodiments, the action requiring authentication may be provided to the mobile application by a third party. For example, if a user is performing an electronic signature for an agreement with a third party, the third party may request the user be authenticated using the smart card before accepting the electronic signature as valid.

In block 154, the method may include generating (e.g., via mobile device system 320A) second data including an authentication flag from the first data. The mobile device may customize or modify the first data for use for user authentication or user identity by inserting an authentication flag into the first data. For example, in some embodiments, the mobile device may generate transaction data that includes the first data received by the mobile device and that further includes an authentication flag. In some embodiments, the authentication flag may indicate a request for authentication. The transaction data generated by the mobile device may include a zero-amount authorization. According to some embodiments, the authentication flag may be placed in a conventionally unused field of the transaction data. In some embodiments, the authentication flag may be inserted as a particular prefix and/or suffix to a portion of the first data (e.g., as a prefix to a merchant identifier). The mobile device may otherwise act as a conventional EMV point-of-sale device for reading information received from the EMV transaction card and generating EMV data for transmission (e.g., packaging the EMV cryptogram, adding merchant data if appropriate, adding data regarding a price or cost).

In block 156, the method may include transmitting (e.g., via mobile device system 320A) the second data to a card network. The mobile device may act as a conventional EMV point-of-sale device (e.g., merchant device) for transmitting the card information and/or second data to the card network. According to some embodiments, the second data may be transmitted to the card network via an acquirer and the acquirer may determine the card network from a plurality of card networks. For example, in some embodiments, the acquirer may identify a PAN included in the second data and may select a card network known to be associated with the PAN.

In block 158, the method may include receiving (e.g., via mobile device system 320A) identity information to authenticate the user from the card network. In some embodiments, the identity information may include information about a cardholder associated with a PAN (or other identifier) included in the first data. For example, in some embodiments, the identity information may include one or more of a name, phone number, email address, and/or device identification numbers. In some embodiments, the identity information may be derived from a PAN, EMV cryptogram, or other identifier included in the first data. For example, in some embodiments, a node of the payment processing system (e.g., a card network or issuer) may identify a PAN in the first data (e.g., by decrypting a cryptogram of the first data) and then may determine identity information associated with the PAN by performing a look-up in a stored table that associates PANs with user identity information. Thus, for example, if the PAN contained within the first data is “1234123412341234,” the node of the payment processing system (e.g., the card network) may access a stored table of PAN numbers, lookup “1234123412341234,” in the table and identify identity information associated with that PAN number in the table such as a stored name, phone number, email address, zip code or other such information and may transmit some or all such information associated with the PAN number as identity information to the mobile device (e.g., mobile device system 320A), which may be used by the mobile device to perform an authentication of the user.

According to some embodiments, the identity information may be a true or false indication from the card network that the identity information was verified against the identity information retrieved at the card network. For example, as will be understood by those of skill in the art, EMV data that may be included in the first data can include a card holder name and zip code. Thus, in some embodiments, the node of the payment processing system (e.g., the card network) may obtain a name and/or zip code from the first data and compare it with a stored name and/or zip code that is stored in a table in association with a PAN that matches the PAN that is also obtained from the first data. According to some embodiments, if the stored name and/or zip code matches the name and/or zip code received from the first data, the node of the payment processing network may determine that the user has been authenticated and may transmit identity information that is a binary indication that the user has positively been authenticated. Conversely, if the stored name and/or zip code does not match the name and/or zip code received from the first data, the node of the payment processing network may determine that the user has not been authenticated and may transmit identity information that is a binary indication that the user has not been authenticated.

According to some embodiments, the identity information is not received from the card network via an acquirer. In some embodiments, the identity information may be transmitted from the card network to the mobile device directly, for example, via the Internet, via a cellular data network or the like. In some embodiments, the card network may be configured to communicate directly to a mobile application running on the mobile device.

In some embodiments, the method 150 may further include generating, at the mobile device, a third graphical user interface showing that the user is authenticated in response to receiving the identity information from the card network to authenticate the user and displaying the third graphical user interface on the display of the mobile device. In some embodiments, the user may be authenticated by the mobile device by comparing the received identity information to stored identity information and determining the two sets of identity information match. Thus, in some embodiments, the mobile device may generate the third GUI in response to determining that the received identity information matches stored identity information of the user.

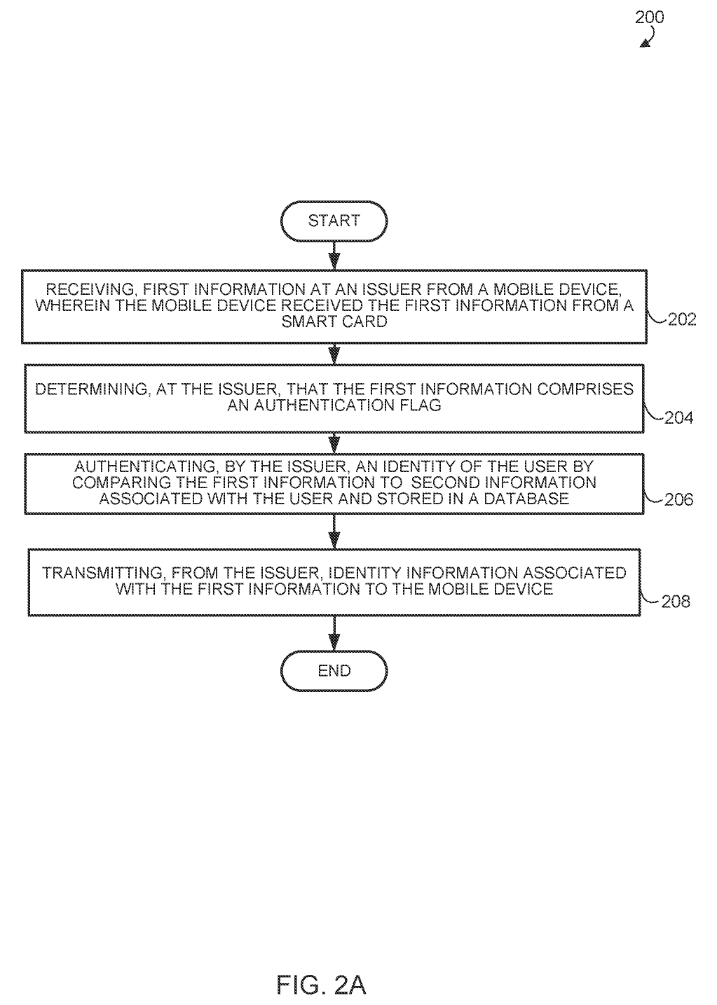

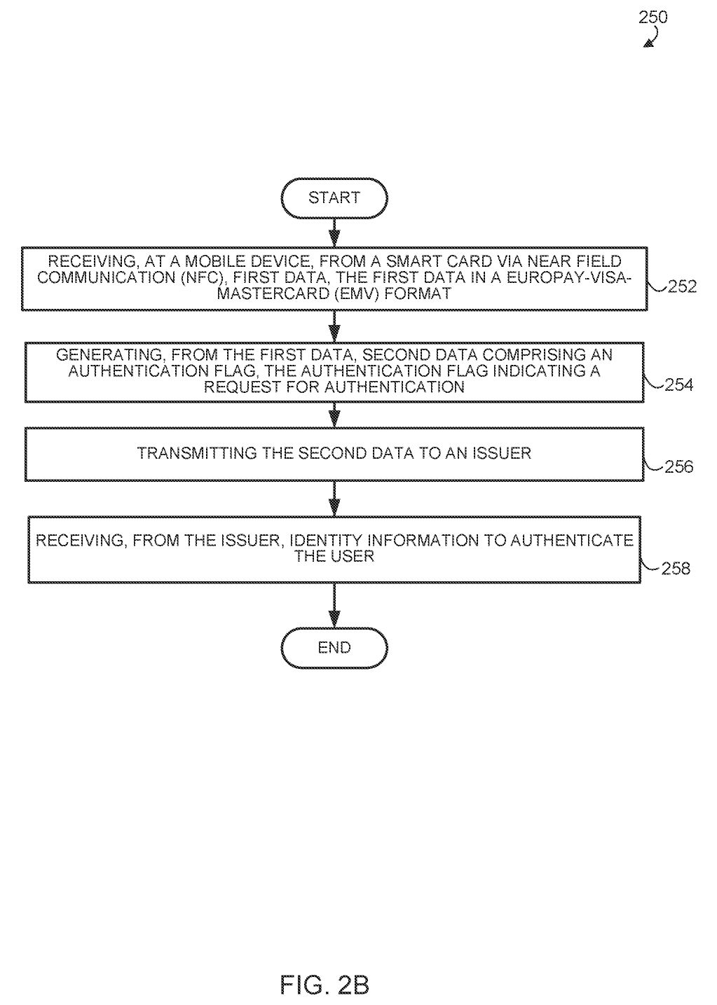

FIG. 2A is a flow diagram illustrating an exemplary method 200 for authenticating a user at an issuer, in accordance with certain embodiments of the disclosed technology. The steps of method 200 may be performed by one or more components of the system 400 (e.g., authentication system 320B, or web server 410 of system 408), as described in more detail with respect to FIGS. 3B and 4. Further, elements of the system 400 may be incorporated into acquirer, card network or issuer systems as described with respect to FIGS. 5A-9.

In block 202, the method may include receiving first information from a mobile device (e.g., via mobile device system 320A) at an issuer. In some embodiments, the mobile device may have received the first information from a smart card.

Similar to the description above with respect to FIG. 1A, in some embodiments, the mobile device may receive the first information from the smart card via near field communication (NFC), the first information may be in a Europay-Visa-Mastercard (EMV) format, and the first information may be generated by an EMV applet on the smart card.

In some embodiments, the first information may be received via an acquirer and a card network. In other words, in some embodiments, the first information may be transmit from the mobile device to an acquirer, transmit from the acquirer to a card network, and transmit from the card network to the issuer. In some embodiments, the card network may identify the issuer from a plurality of issuers, for example, by identifying an issuer associated with a PAN included in the first information.

In block 204, the method may include determining that the first information includes an authentication flag. According to some embodiments, the determination that the first information includes an authentication flag may be made at the issuer. For example, in some embodiments, the issuer may be configured to scan the first information and identify one or more particular flags contained within the first information, such as a particular value stored in a particular location in a data structure of the information or a particular prefix or suffix appended to a particular portion of the information.

In block 206, the method may include authenticating, by the issuer, an identity of the user by comparing the first information to second information associated with the user and stored in a database. In some embodiments, the issuer may alternatively forward the first information to an authentication system (e.g., authentication system 320B) that performs the authentication. According to some embodiments, performing the authentication may include for example, identifying a PAN number in the first information, performing a lookup in a stored table of PAN numbers in the second information and identifying corresponding identity information (e.g., user information and/or device/communication information) stored in the table in association with the PAN.

In block 208, the method may include transmitting identity information associated with the first information from the issuer to the mobile device (e.g., mobile device system 320A). In some embodiments, the identity information may be transmitted to the mobile device directly in a manner similar to that described above with respect to the card network at step 108 of FIG. 1A.

FIG. 2B is a flow diagram illustrating an exemplary method 250 for authenticating a user via an issuer, in accordance with certain embodiments of the disclosed technology. The steps of method 200 may be performed by mobile device system 320A, as described in more detail with respect to FIG. 3A. Further, elements of the system 400 may be incorporated into acquirer, card network or issuer systems as described with respect to FIGS. 5A-9.

In block 252, the method may include receiving first data at a mobile device (e.g., via mobile device system 320A). As described previously above, in some embodiments, the first data may be received from a smart card via near field communication (NFC). Furthermore, the first data may be in a Europay-Visa-Mastercard (EMV) format and may have been generated by an EMV applet on the smart card.

According to some embodiments, the method 250 may further include receiving an action requiring authentication from the user via a first graphical user interface on a mobile application on the mobile device, generating, at the mobile device, a second graphical user interface requesting the user locate the smart card near the mobile device, and displaying the second graphical user interface on a display of the mobile device. The mobile application may cause the mobile device to be in a state ready to receive (e.g., via NFC) information from the smart card in response to, for example, the user tapping the smart card to a reader of the mobile device. In some embodiments, an action requiring authentication may be provided to the mobile application in response to an attempted purchase by the user. In some embodiments, the action requiring authentication may be provided to the mobile application by a third party. For example, if a user is performing an electronic signature for an agreement with a third party, the third party may request the user be authenticated using the smart card before accepting the electronic signature as valid.

In block 254, the method may include generating (e.g., via mobile device system 320A) second data including an authentication flag from the first data in a manner similar to that described above with respect to block 154 of FIG. 1B. In some embodiments, the authentication flag may indicate a request for authentication.

In block 256, the method may include transmitting (e.g., via mobile device system 320A) the second data to an issuer. According to some embodiments, the second data may be transmitted to the issuer via an acquirer and a card network. In some embodiments, the card network may select the issuer from a plurality of issuers. For example, in some embodiments, the card network may identify a PAN included in the second data and may select an issuer known to be associated with the PAN.

In block 258, the method may include receiving (e.g., via mobile device system 320A) identity information to authenticate the user from the issuer. In some embodiments, the identity information may include information about a cardholder associated with a PAN (or other identifier) included in the first data. For example, in some embodiments, the identity information may include one or more of a name, phone number, email address, and/or device identification numbers.

According to some embodiments, the identity information is not received from the issuer via a card network and/or an acquirer. In some embodiments, the identity information may be transmitted from the issuer to the mobile device directly, for example, via the Internet, via a cellular data network or the like. In some embodiments, the issuer may be configured to communicate directly to a mobile application running on the mobile device.

In some embodiments, the method 250 may further include generating, at the mobile device, a third graphical user interface showing that the user is authenticated in response to receiving the identity information from the card network to authenticate the user and displaying the third graphical user interface on the display of the mobile device. In some embodiments, the user may be authenticated by the mobile device by comparing the received identity information to stored identity information and determining the two sets of identity information match. Thus, in some embodiments, the mobile device may generate the third GUI in response to determining that the received identity information matches stored identity information of the user.

Although FIGS. 2A and 2B are directed to methods of authenticating a user via an issuer, it should be understood that it is contemplated that the issuer may also perform one or more of the various steps or functions performed by the card network as described above in relation to the methods shown in FIGS. 1A and 1B. In other words, it is contemplated that depending on the embodiment, either the card network or the issuer may perform the disclosed steps for performing an authentication of the user and those steps may be substantially similar in either case.

FIG. 3A is a block diagram of an example mobile device system 320A used to generate transaction data having an authentication flag for use with a payment processing infrastructure to authenticate a user, according to an example implementation of the disclosed technology. The mobile device system 320A may run and display one or more applications and the related output(s) of the one or more programs (e.g., through APIs) 350A. The mobile device system 320A may include a card reader (not shown) or one or more components that may function to read from and/or communicate with a contactless card (e.g., a digital card reader), such as a smart card. In conjunction with the one or more programs 350A, the card reader may communicate with one or more smart cards. According to some embodiments, the mobile device system 320A may be configured to receive data from a smart card, for example via near filed communication (NFC). According to some embodiments, the smart card may communicate data and/or information to the mobile device system 320A in a Europay-Visa-Mastercard (EMV) format. Such EMV-formatted data may be generated by an EMV applet on the smart card. The mobile device system 320A may include software that allows the mobile device system 320A to process EMV transactions in a manner similar to that of a merchant point-of-sale device. In other words, the mobile device system 320A may include software that allows the mobile device system 320A to generate transaction data in response to, for example, a transaction card with an EMV chip being tapped to a wireless reader of the mobile device system 320A and communicate that transaction data to one or more nodes of a payment processing system (e.g., to an acquirer, a card network and/or an issuer).

According to some embodiments, the mobile device system 320A may store user identity information. For example, the mobile device system 320A may store the user’s name, phone number, address, email address, username, password and the like. In some embodiments, the mobile device system 320A may include a user authentication feature that may require the user to authenticate themselves to access information and/or functionalities stored on the mobile device system 320A. For example, in some embodiments, the user may authenticate themselves to the mobile device system 320A by for example, logging in with user credentials (e.g., username and password), biometric data (e.g., facial scan), an established gesture associated with user recognition and/or other such authentication techniques (e.g., two factor authentication). According to some embodiments, when the user authenticates themselves to the mobile device system 320A, the user may be granted access to certain first-level user account options (e.g., access to certain data and/or functionalities). As described further below, in some embodiments, a user may perform a secondary user authentication using a smart card associated with the user, which may grant the user access to certain second-level user account options via the mobile device system 320A.

In certain implementations according to the present disclosure, a smart card may include a radio frequency identification chip enabled to communicate via near field communication (NFC) or other short-range communication protocols. In other embodiments, a smart card may communicate through other means including, but not limited to, Bluetooth, satellite, and/or Wi-Fi. According to some embodiments, a smart card may communicate with the card reader through near field communication when the smart card is within range of the card reader of mobile device system 320A. The smart card may send to the program 350A a certificate authority public key and cardholder identification information of an account holder. The cardholder identification information may include a personal identification number (PIN), a name of the user, an address, a date of birth, and/or the like. In response to instructions from the program 350A, the smart card may extract the issuer public key from the smart card. The program 350A may use the issuer public key to extract the card public key of a key pair from smart card. The program 350A may instruct the smart card to generate a digital signature using the card private key of the key pair. In some embodiments, the smart card may send the digital signature to the mobile device system 320A. The mobile device system 320A may verify the digital signature using the card public key. The processor 310A may compare at least a portion of the user identity with at least a portion of the cardholder identification information. In some embodiments, upon determining a second match between the user identity (e.g., the identity previously authenticated by program 350A) and the cardholder identification information obtained from the smart card, the program 350A may grant the user access to one or more second-level user account options of a user account. According to some embodiments, such cardholder identification information used for this comparison may alternatively be obtained from a card network or issuer as part of one or more authentication processes that are described with respect to FIGS. 1A-2B and 6-9. According to some embodiments, the second-level user account options have a higher security requirement than the first-level user account options. As non-limiting examples, the second-level user account options of a user account may include a payment transfer, a payment request, a personal identification number (PIN) change request, an address change request, a card activation, and/or the like.

In some embodiments, the mobile device system 320A may include a mobile application, such as for example, a merchant mobile application used to purchase items and/or a mobile banking software application, that may provide a prompt in a graphical user interface (GUI) of the mobile application for the user to authenticate themselves using their smart card, by for example, tapping the smart card to the mobile device system 320A. In some embodiments, the mobile application may require the user to be authenticated to access an account on the mobile application by for example, logging into the account in a manner similar to that described previously above with respect to the user authenticating themselves to access data on the mobile device system 320A. Thus, for example, in some embodiments, if a purchase is made with the user’s smart card while the user is logged into an account via the mobile application, the mobile application may act to authenticate the user to determine that the purchase is not fraudulent by requesting authentication using the smart card by, for example, requesting that the user tap the smart card to the mobile device system 320A. In this way, the mobile application can authenticate that the user and/or transaction is valid because the user has already undergone one authentication process by virtue of having been logged into their account via the mobile application and the second authentication process executed by tapping their smart card to the mobile device system 320A can demonstrate that the person who has logged into the user account associated with the smart card is also in physical possession of the smart card, thereby significantly reducing the risk of fraud.

In some embodiments, the user may not be required to be logged into an account associated with the mobile application but may simply be using the mobile application as an unregistered or unlogged-in user. In such cases a user may, for example, manually enter an account identifier (e.g., a PAN) into a payment form of the mobile application (or merchant website) and in response to determining a purchase is being attempted the mobile application (or browser extension) may prompt the user to perform an authentication by tapping their smart card to the mobile device system 320A.

In some embodiments, the mobile application may be a stand-alone application that is downloaded and launched on the mobile device system 320A. In some embodiments, the mobile application may be a browser extension installed on a browser of the mobile device system 320A, which performs functions described herein when the user of the mobile device system 320A uses the browser. According to some embodiments, the mobile application may be configured to monitor the user’s actions and determine, for example, when the user is attempting to make a purchase at a merchant. In some embodiments, in response to determining that the user is attempting to make a purchase, the mobile application may prompt the user (e.g., via a GUI displayed on the mobile device system 320A) to tap a smart card to the mobile device system 320A to perform a user authentication process.

Upon the user tapping the smart card to the mobile device system 320A, the data received by the mobile device system 320A from the smart card may be in a Europay-Visa-Mastercard (EMV) format. As will be appreciated by those of skill in the art, conventional smart cards include an applet configured to transmit data in EMV format for the purpose of, for example, conducting a financial transaction. EMV data may include cardholder information and account information (e.g., a primary account number (PAN)). The mobile device system 320 may be configured to generate transaction data that includes the EMV data. In some embodiments, the transaction data may be data associated with a real transaction (e.g., a purchase at a merchant) being made by the user in conjunction with the authentication. According to some embodiments, the mobile device system 320A may receive data to generate the transaction data from the merchant (e.g., from a merchant POS or via a website of the merchant at which a transaction is being conducted using mobile device system 320A), such as merchant code information, transaction amount, time/date and other such information as may be included with transaction data in association with a purchase at a merchant. In some embodiments, the transaction data may be data associated with a mock transaction that is created by the mobile device system 320A for the purpose of submitting the transaction data to the payment processing infrastructure to perform an authentication as described herein. In some embodiments, the mobile device system 320A may generate transaction data for a zero-dollar transaction (i.e., transaction data where a transaction amount field is set to “$0.00”). The transaction data generated by the mobile device system 320A may incorporate some or all of the received data (e.g., EMV data) received from the smart card.

According to some embodiments, the mobile device system 320A may be configured to generate an authentication flag and modify the transaction data to include the authentication flag (e.g., via the mobile application on mobile device system 320A). For example, in some embodiments, conventional transaction data may have a specific data format that may include a number of empty cells (or cells having a default value of zero) that are not conventionally used for any purpose but one cell of which may be modified (e.g., by changing a default value of “0” to a value of “1”) by the mobile device system 320A in some way to represent an authentication flag. In some embodiments, an authentication flag may indicate a request for authentication (e.g., of a user). In some embodiments, an authentication flag may be added to the transaction data by, for example, appending a prefix or a suffix to a portion of the transaction data. For example, in one embodiment, the mobile device system 320A may append a prefix such as “***” or “AAA” to a field in the transaction data that provides an indication of the merchant name. The modified transaction data (i.e., including the authentication flag) may be communicated by the mobile device system 320A to the payment processing infrastructure (e.g., to an acquirer), as though it is a typical transaction request that would be generated by a merchant based on an attempted purchase. For example, in some embodiments, a mobile application on the mobile device system 320A may be configured to communicate with the payment processing infrastructure as though it were a merchant. It will be understood that these examples are illustrative and non-limiting, and it is contemplated that there may be many different ways the transaction data could be modified to include an authentication flag.

As described herein, the payment processing infrastructure (i.e., the acquirer, card network and/or issuer) may receive the modified transaction data from the mobile device system 320A and process the data as though it were normal transaction data received from a merchant. However, in some embodiments, a portion of the payment processing infrastructure (e.g., the card network or the issuer) may be configured to detect the presence of the authentication flag in the transaction data, which may cause the transaction to be routed to an authentication process. According to some embodiments, routing the transaction to an authentication process may cause abandonment of the processing of the transaction data as though it were a real transaction. In some embodiments, the transaction may continue to be processed like a normal transaction in parallel to the authentication process, for example, in a case where the authentication is taking place concurrently with an actual purchase being made using the smart card. In some embodiments, the mobile device system 320A may use different flags to indicate an authentication-only request (i.e., there is no purchase being made) and an authentication that is being requested as part of a purchase transaction that is being made with the smart card. For example, different prefixes may be used or different values may be placed in an empty cell in the transaction data.

According to some embodiments, authentication system 320B as depicted in FIG. 3B, and the user device 402 and web server 410 as depicted in FIG. 4 and described below, may have a similar structure and components that are similar to those described with respect mobile device system 320A shown in FIG. 3A. As shown, the mobile device system 320A may include a processor 310A, an input/output (I/O) device 370A, a memory 330A containing an operating system (OS) 340A and a program 350A. In some embodiments, the mobile device system 320A may further include a peripheral interface, a transceiver, a mobile network interface in communication with the processor 310A, a bus configured to facilitate communication between the various components of the mobile device system 320A, and a power source configured to power one or more components of the mobile device system 320A.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth^{TM} port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth^{TM}, low-energy Bluetooth^{TM} (BLE), WiFi™, ZigBee^{TM}, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310A may include one or more of a microprocessor, microcontroller, digital signal processor, co-processor or the like or combinations thereof capable of executing stored instructions and operating upon stored data. The memory 330A may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330A.

The processor 310A may be one or more known processing devices, such as, but not limited to, a microprocessor from the Core^{TM} family manufactured by Intel^{TM}, the Ryzen^{TM} family manufactured by AMD^{TM}, or a system-on-chip processor using an ARM^{TM} or other similar architecture. The processor 310A may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310A may be a single core processor that is configured with virtual processing technologies. In certain embodiments, the processor 310A may use logical processors to simultaneously execute and control multiple processes. The processor 310A may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the mobile device system 320A may include one or more storage devices configured to store information used by the processor 310A (or other components) to perform certain functions related to the disclosed embodiments. In one example, the mobile device system 320A may include the memory 330A that includes instructions to enable the processor 310A to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The mobile device system 320A may include a memory 330A that includes instructions that, when executed by the processor 310A, perform one or more processes consistent with the functionalities disclosed herein. Methods, systems, and articles of manufacture consistent with disclosed embodiments are not limited to separate programs or computers configured to perform dedicated tasks. For example, the mobile device system 320A may include the memory 330A that may include one or more programs 350A to perform one or more functions of the disclosed embodiments. For example, in some embodiments, the mobile device system 320A may additionally manage dialogue and/or other interactions with the customer via a program 350A.

The processor 310A may execute one or more programs 350A located remotely from mobile device system 320A. For example, the mobile device system 320A may access one or more remote programs that, when executed, perform functions related to disclosed embodiments.

The memory 330A may include one or more memory devices that store data and instructions used to perform one or more features of the disclosed embodiments. The memory 330A may also include any combination of one or more databases controlled by memory controller devices (e.g., server(s), etc.) or software, such as document management systems, Microsoft^{TM} SQL databases, SharePoint^{TM} databases, Oracle^{TM} databases, Sybase^{TM} databases, or other relational or non-relational databases. The memory 330A may include software components that, when executed by the processor 310A, perform one or more processes consistent with the disclosed embodiments. In some embodiments, the memory 330A may include a mobile device system database 360A for storing related data to enable the mobile device system 320A to perform one or more of the processes and functionalities associated with the disclosed embodiments.

The mobile device system database 360A may include stored data relating to status data (e.g., average session duration data, location data, idle time between sessions, and/or average idle time between sessions) and historical status data. In some embodiments, the mobile device system database 360A may store data used for creating mock transaction data and data representing one or more types of flags and their associated meanings. For example, mobile device system database 360A may store a plurality of different prefixes that each represent a different type of flag, such as an authentication flag without a purchase transaction, an authentication flag with a purchase transaction, and flags representing other types of authentications or other types of functions.

The mobile device system 320A may also be communicatively connected to one or more memory devices (e.g., databases) locally or through a network. The remote memory devices may be configured to store information and may be accessed and/or managed by the mobile device system 320A. By way of example, the remote memory devices may be document management systems, Microsoft^{TM} SQL database, SharePoint^{TM} databases, Oracle^{TM} databases, Sybase^{TM} databases, or other relational or non-relational databases. Systems and methods consistent with disclosed embodiments, however, are not limited to separate databases or even to the use of a database.

The mobile device system 320A may also include one or more I/O devices 370A that may comprise one or more interfaces for receiving signals or input from devices and providing signals or output to one or more devices that allow data to be received and/or transmitted by the mobile device system 320A. For example, the mobile device system 320A may include interface components, which may provide interfaces to one or more input devices, such as one or more keyboards, mouse devices, touch screens, track pads, trackballs, scroll wheels, digital cameras, microphones, sensors, and the like, that enable the mobile device system 320A to receive data from a user.

In examples of the disclosed technology, the mobile device system 320A may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the mobile device system 320A has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the mobile device system 320A may include a greater or lesser number of components than those illustrated.

FIG. 3B is a block diagram of an example authentication system 320B used to perform an authentication of a user or transaction based on received transaction data according to an example implementation of the disclosed technology. According to some embodiments, the authentication system 320B may be configured to receive transaction data (e.g., transaction data generated by mobile device system 320B as described previously above) and compare a portion of the transaction data, such as data including a PAN number (e.g., as derived from EMV data), to a table of stored user information. For example, in some embodiments, the authentication system 320B may include a table (or database) that may include a list of PANs, identity information associated with the user/card holder associated with each PAN and device information (which may also be referred to as communication information) associated with the user. According to some embodiments, the authentication system 320B may identify a PAN from the transaction data, compare it to the table of stored data to determine identity information of a user associated with the PAN and device information associated with the user. According to some embodiments, the authentication system 320B may be configured to store one or more cryptographic keys that may allow it to decrypt a cryptogram provided in the EMV data that contains the PAN associated with the smart card.

Using the device information, the authentication system 320B may be configured to transmit the identity information associated with the user that is associated with the PAN to the device that is associated with the user. According to some embodiments, the device information may include information sufficient to allow the authentication system 320B to communicate directly with the mobile device. For example, in some embodiments, the device information may include a phone number associated with the user’s mobile device, and based on the phone number, the authentication system 320B may be configured to send the identity information to a mobile application (e.g., a mobile banking software application) that is installed on the mobile device associated with that phone number. In some embodiments, once received by the mobile device (e.g., mobile device system 320A), the mobile device may authenticate the user by, for example, comparing the received user identity information to identity information stored on the mobile device and determining whether they match. For example, in some embodiments, a mobile application running on the mobile device of the user may receive the user identity information from the authentication system 320B and compare it with stored user identity information (e.g., name of the user, date of birth, etc.) and if they match then the mobile application may determine that the user is authenticated and may communicate that message to an entity that was requesting the authentication.

In some embodiments, the authentication system 320B may authenticate the user itself by for example, receiving user identity information as part of the transaction data and comparing the received user identity information to user identity information to information stored by the authentication system 320B. For example, as described previously, the authentication system 320B may store a table of PANs and associated card holder information and thus may compare a PAN and user identity information received in transaction data to the data stored in the table to determine if the user identity information stored in association with the PAN matches the received user identity information. According to some embodiments, if these sets of user identity information match, the authentication system 320B may transmit a message to the device associated with the user that indicates that the user has been authenticated.

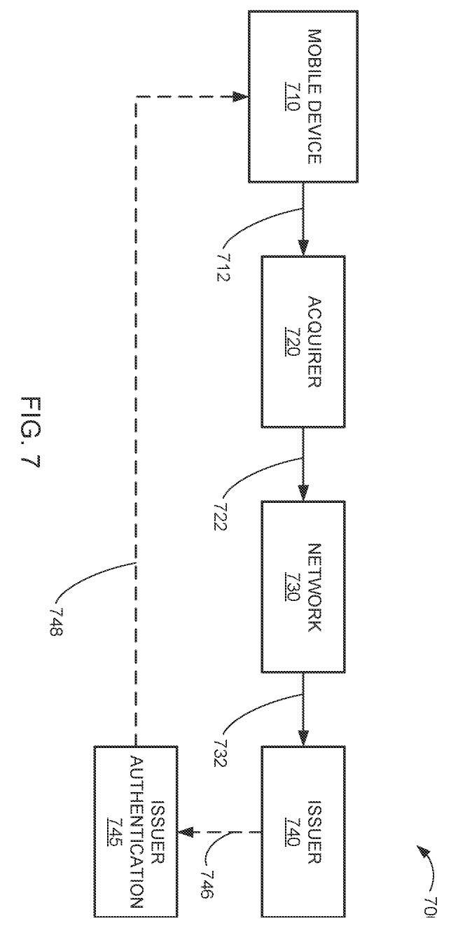

As will be explained below with respect to FIGS. 6-9, although the authentication system 320B may receive the transaction data via the payment processing infrastructure, when communicating the identity information to the mobile device associated with the PAN included with the transaction data, the authentication system 320B may bypass elements of the payment processing architecture and communicate with the mobile device (e.g., mobile device system 320A) directly (e.g., via the Internet or other network communication).

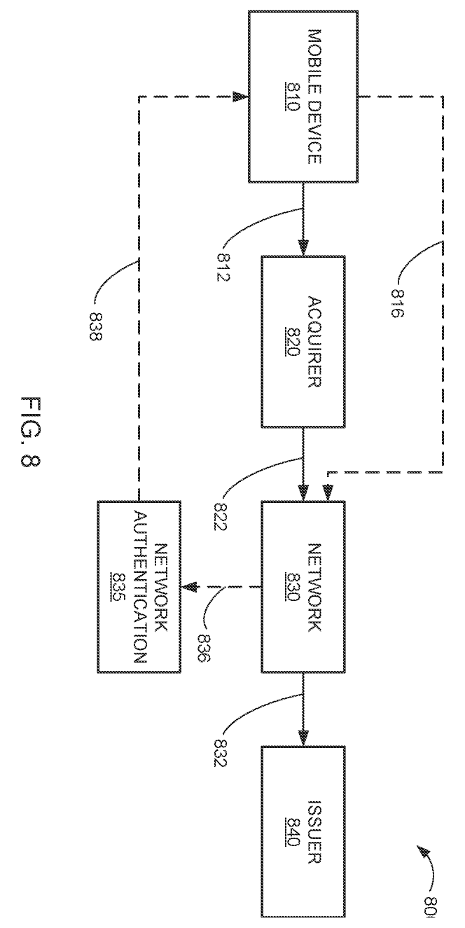

According to some embodiments, the user device 402 and web server 410, as depicted in FIG. 4 and described below, may have a similar structure and components that are similar to those described with respect authentication system 320B shown in FIG. 3B. As shown, the authentication system 320B may include a processor 310B, an input/output (I/O) device 370B, a memory 330B containing an operating system (OS) 340B and a program 350B. In certain example implementations, the authentication system 320B may be a single server or may be configured as a distributed computer system including multiple servers or computers that interoperate to perform one or more of the processes and functionalities associated with the disclosed embodiments. In some embodiments, the authentication system 320B may be one or more servers from a serverless or scaling server system. In some embodiments, the authentication system 320B may further include a peripheral interface, a transceiver, a mobile network interface in communication with the processor 310B, a bus configured to facilitate communication between the various components of the authentication system 320B, and a power source configured to power one or more components of the authentication system 320B. In some embodiments, the network authentication system 320B may be configured to receive transaction data forwarded to it by a card network (e.g., card network 630 shown in FIG. 6) or by an issuer (e.g., issuer 740 shown in FIG. 7). According to some embodiments, the network authentication system 320B may be incorporated as part of a card network system (e.g., card network 630) or issuer (e.g., issuer 740).

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth^{TM} port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth^{TM}, low-energy Bluetooth^{TM} (BLE), WiFi™, ZigBee^{TM}, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310B may include one or more of a microprocessor, microcontroller, digital signal processor, co-processor or the like or combinations thereof capable of executing stored instructions and operating upon stored data. The memory 330B may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330B.

The processor 310B may be one or more known processing devices, such as, but not limited to, a microprocessor from the Core^{TM} family manufactured by Intel^{TM}, the Ryzen^{TM} family manufactured by AMD^{TM}, or a system-on-chip processor using an ARM^{TM} or other similar architecture. The processor 310B may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310A may be a single core processor that is configured with virtual processing technologies. In certain embodiments, the processor 310B may use logical processors to simultaneously execute and control multiple processes. The processor 310B may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the authentication system 320B may include one or more storage devices configured to store information used by the processor 310B (or other components) to perform certain functions related to the disclosed embodiments. In one example, the authentication system 320B may include the memory 330B that includes instructions to enable the processor 310B to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The authentication system 320B may include a memory 330B that includes instructions that, when executed by the processor 310B, perform one or more processes consistent with the functionalities disclosed herein. Methods, systems, and articles of manufacture consistent with disclosed embodiments are not limited to separate programs or computers configured to perform dedicated tasks. For example, the authentication system 320B may include the memory 330B that may include one or more programs 350B to perform one or more functions of the disclosed embodiments. For example, in some embodiments, the authentication system 320B may additionally manage dialogue and/or other interactions with the customer via a program 350A.

The processor 310B may execute one or more programs 350B located remotely from authentication system 320B. For example, the authentication system 320B may access one or more remote programs that, when executed, perform functions related to disclosed embodiments.

The memory 330B may include one or more memory devices that store data and instructions used to perform one or more features of the disclosed embodiments. The memory 330B may also include any combination of one or more databases controlled by memory controller devices (e.g., server(s), etc.) or software, such as document management systems, Microsoft^{TM} SQL databases, SharePoint^{TM} databases, Oracle^{TM} databases, Sybase^{TM} databases, or other relational or non-relational databases. The memory 330B may include software components that, when executed by the processor 310B, perform one or more processes consistent with the disclosed embodiments. In some embodiments, the memory 330B may include an authentication system database 360B for storing related data to enable the authentication system 320B to perform one or more of the processes and functionalities associated with the disclosed embodiments.

The authentication system database 360B may include stored data relating to status data (e.g., average session duration data, location data, idle time between sessions, and/or average idle time between sessions) and historical status data. In some embodiments, the authentication system database 360B may store a table of identification information that may include for example, primary account numbers (PANs) that are associated with corresponding card holders, as well as identity information and/or device (e.g., mobile device) information associated with the card holder (e.g., a device identification number, a phone number, a number/string identifying an instance of a mobile application installed on a device associated with or logged into by the card holder, etc.). According to some embodiments, the functions provided by the authentication system database 360B may also be provided by a database that is external to authentication system 320B, such as the database 416 as shown in FIG. 4.

The authentication system 320B may also be communicatively connected to one or more memory devices (e.g., databases) locally or through a network. The remote memory devices may be configured to store information and may be accessed and/or managed by the authentication system 320B. By way of example, the remote memory devices may be document management systems, Microsoft^{TM} SQL database, SharePoint^{TM} databases, Oracle^{TM} databases, Sybase^{TM} databases, or other relational or non-relational databases. Systems and methods consistent with disclosed embodiments, however, are not limited to separate databases or even to the use of a database.

The authentication system 320B may also include one or more I/O devices 370B that may comprise one or more interfaces for receiving signals or input from devices and providing signals or output to one or more devices that allow data to be received and/or transmitted by the authentication system 320B. For example, the authentication system 320B may include interface components, which may provide interfaces to one or more input devices, such as one or more keyboards, mouse devices, touch screens, track pads, trackballs, scroll wheels, digital cameras, microphones, sensors, and the like, that enable the authentication system 320B to receive data from a user.

In examples of the disclosed technology, the authentication system 320B may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the authentication system 320B has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the authentication system 320B may include a greater or lesser number of components than those illustrated.

FIG. 4 is a block diagram of an example system that may be used to view and interact with system 408, according to an example implementation of the disclosed technology. The components and arrangements shown in FIG. 4 are not intended to limit the disclosed embodiments as the components used to implement the disclosed processes and features may vary. As shown, system 408 may interact with a user device 402 (which may be mobile device system 320A) via a network 406. In certain example implementations, the system 408 may include a local network 412, an authentication system 320B, a web server 410, and a database 416. According to some embodiments, the user device 402 may be the mobile device system 320B described above with respect to FIG. 3A. According to some embodiments, some or all of system 408 may be incorporated as part of an acquirer, a card network and/or an issuer system(s) (e.g., such as acquirer 620, card network 630 and issuer 640 shown in FIG. 6).

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or Wi-Fi networks. In some embodiments, the network 406 may connect terminals, services, and mobile devices using direct connections such as radio-frequency identification (RFID), near-field communication (NFC), Bluetooth^{TM}, low-energy Bluetooth^{TM} (BLE), Wi-Fi^{TM}, ZigBee^{TM}, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The system 408 may be associated with and optionally controlled by one or more entities such as a business, corporation, individual, partnership, or any other entity that provides one or more of goods, services, and consultations to individuals such as customers. In some embodiments, the system 408 may be controlled by a third party on behalf of another business, corporation, individual, partnership. The system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website or a merchant website that a user device may access by providing an attempted login that are authenticated by the authentication system 320B. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure^{TM} or Amazon Web Services^{TM}.

The local network 412 may include any type of computer networking arrangement used to exchange data in a localized area, such as Wi-Fi, Bluetooth^{TM}, Ethernet, and other suitable network connections that enable components of the system 408 to interact with one another and to connect to the network 406 for interacting with components in the system 400 environment. In some embodiments, the local network 412 may include an interface for communicating with or linking to the network 406. In other embodiments, certain components of the system 408 may communicate via the network 406, without a separate local network 406.

The system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access system 408 using the cloud computing environment. User device 402 may be able to access system 408 using specialized software. The cloud computing environment may eliminate the need to install specialized software on user device 402.

In accordance with certain example implementations of the disclosed technology, the system 408 may include one or more computer systems configured to compile data from a plurality of sources including the mobile device system 320A, the authentication system 320B, web server 410, and/or the database 416. The authentication system 320B may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, authentication system database 360B, as discussed with reference to FIG. 3B.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be "clustered," for example, a group of datasets may share common features, such as overlapping data, shared statistical properties, or the like. Clustered datasets may share hierarchical relationships (e.g., data lineage).

As will be recognized by those of skill in the art, in at least some exemplary financial transactions (e.g., credit card transactions), there may be at least two phases: authorization and settlement. In the authorization phase, a merchant may perform various actions to find out whether a customer’s desired transaction is valid (e.g., if the customer has sufficient funds in his or her account or sufficient credit available to make a particular purchase). FIG. 5A is a flow diagram illustrating a method 500a for seeking authorization for a transaction from an issuer and FIG. 5B is a flow diagram illustrating a method 500b for receiving a transaction authorization or denial from an issuer. The methods 500a, 500b depicted in FIGS. 5A and 5B may include a merchant 510 (e.g., in some embodiments, may be a mobile device like mobile device 320A used to process EMV transactions), an acquirer 520, a card network 530 and an issuer 540, each of which may be systems that include one or more network-enabled computers to process instructions for authorizing and settling a financial transaction. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the systems illustrated in FIGS. 5A and 5B may execute one or more software applications to, for example, receive data as input from an entity accessing the network-enabled computer, process received data, transmit data over a network, and receive data over a network. The one or more network-enabled computers may also include one or more software applications to enable the processing of a card transaction.

The components of the systems depicted in FIGS. 5A and 5B may be coupled via one or more networks. As referred to herein, a network may include, but is not limited to: e.g., a wide area network (WAN), a local areas network (LAN), a global network such as the Internet, a telephone network such as a public switch network, a wireless communication network, a cellular network, an intranet, or the like, or any combination thereof. The network may include one, or any number of the exemplary types of networks mentioned above, operating as a stand-alone network or in cooperation with each other. Use of the term network herein is not intended to limit the network to a single network. The systems depicted in FIGS. 5A and 5B (i.e., merchant 510, acquirer 520, card network 530 and issuer 540) may communicate by electronic transmission through the one or more networks mentioned above, by physical delivery, or by any other communication mechanism. Communication between two components/systems depicted in FIGS. 5A and 5B may also include communication with any other entities between the two components/systems.

Although not depicted in FIGS. 5A and 5B, it will be understood by those of skill in the art that a customer having a transaction card (e.g., a smart card) may interact with merchant 510 (e.g., via a merchant POS device or via a website) to initiate and execute a financial transaction. For example, the customer may desire to purchase goods or services from the merchant 510. The customer may use a unique customer identifier to conduct the transaction with the merchant 510. The customer identifier may be any sequence of letters, numbers, characters, or symbols of any length and may be associated with a payment mechanism, including, without limitation, a credit card, debit card, smart card, charge card, or any other mechanism for making payment. The payment mechanism may be issued to the customer by a card issuer 540 (which may also be referred to as “issuer 540”), such as, for example, a bank where the customer has an account, another financial institution, or any other entity. As used herein, the term account may include any place, location, object, entity, or other mechanism for holding money or performing monetary transactions in any form, including, without limitation, electronic form. An account may be, for example, a prepaid card account, stored value card account, debit card account, check card account, payroll card account, gift card account, prepaid credit card account, charge card account, checking account, rewards account, line of credit account, or credit account.

In just one example, the customer may have a credit card that allows the customer to make purchases on credit up to a specified dollar limit and repay the issuer 540 for those purchases over time by making monthly payments. The issuer 540 may pay for the purchases of the customer at the time of purchase on behalf of the customer and charge the customer interest for using its credit services. Also, the customer may use a charge card wherein the balance of the customer’s card may be paid off monthly. Also, the customer may use a debit card wherein amounts for the purchases may be electronically debited from a checking or other account held by the customer at the issuer 540.

The customer identifier of the customer may also be associated with a card network 530, which may, for example, administer cards and act as a gateway between the merchant 510 from which the customer desires to make a purchase and the issuer 540 for processing transactions. Exemplary card networks 530 may include, without limitation, for example, Visa®, MasterCard®, Discover® and American Express®.

A merchant 510 may be any entity capable of accepting a customer identifier as payment. The merchant 510 may receive payments for the merchant’s card transactions in various ways, such as a bank account held by the merchant 510. For example, the merchant 510 may establish a direct deposit account or checking account at a bank, such as an acquirer bank 520 (which may be referred to simply as “acquirer 520”).

When a customer desires to make a purchase at the merchant 510, the customer may provide the merchant 510 with his or her customer identifier to purchase desired goods or services or conduct another type of financial transaction. For example, and without limitation, the customer may swipe his or her credit card in person at the location of the merchant 510 using a register, card payment terminal, or point of sale (POS) system, which may read the customer identifier from the magnetic stripe on the card. Also, the customer identifier may be provided via a bar code on the card. Also, the customer identifier may be provided via radio-frequency identification (RFID) or other automatic identification mechanisms. Also, the customer identifier may be provided via near field communication (NFC) by performing a “tap to pay” function at a merchant POS or other device, such as mobile device system 320A. As will be understood by those of skill in the art, smart cards may include EMV chips that can store and wirelessly transmit customer identifier information (e.g., a PAN encrypted in a cryptogram) and other customer information (e.g., name of customer, etc.) to other devices. Various mechanisms for accepting a customer identifier as payment will be recognized by those skilled in the art. Also, the customer may provide the merchant 510 with the customer identifier over the telephone or using a computer. For example, the customer may make a purchase electronically by entering his or her customer identifier and/or other information associated with the desired purchase on the World Wide Web (WWW) site of the merchant 510, a site accessible via a network, or any other site accessible by a communication mechanism. Various mechanisms for conducting online transactions will be recognized by those skilled in the art. The customer may also make a purchase electronically using various payment services, such as, for example, PayPal®.

As indicated by arrow 512, after receiving the customer identifier from the customer, the merchant 510 may begin the process of authorizing the desired transaction by providing an authorization request to the acquirer 520. The authorization request may include, for example, information associated with the amount of the desired transaction, the customer identifier of the customer, and/or any other information associated with the customer or the transaction. In various exemplary embodiments, the merchant 510 may transmit the authorization request to the acquirer 520 electronically over one or more networks.

In various exemplary embodiments, the acquirer 520 may have a predefined relationship, agreement, or arrangement with the merchant 510 to authorize and settle card transactions on behalf of the merchant 510. The acquirer 520 may process transactions for a plurality of merchants and a plurality of customers. For example, TSYS Acquiring Solutions, LLC (TSYS), which those skilled in the art will recognize as an entity that authorizes and settles card transactions, may operate as the acquirer 520.

As indicated by arrow 522, the acquirer 520 may provide the authorization request, or any other authorization data, to a card network 530 associated with the customer identifier of the customer. For example, if the customer attempted to pay for a purchase with a Visa® credit card, the authorization request may be routed to Visa®. If the customer attempted to pay for a purchase with a MasterCard® credit card, the authorization request may be routed to MasterCard®. The card network 530 may perform various actions to verify that the desired transaction may be completed, including, for example, verifying that there may not have been a temporary or permanent hold placed on the card or verifying that one or more predetermined fraud parameters may not have been triggered. In just one example, the card network 530 may verify that the amount of the desired transaction is not unusually large based on the customer's recent purchases.

As indicated by arrow 532, the card network 530 may provide the authorization request, or any other authorization data, such as, for example, information associated with verification of the customer or transaction, as described herein, to the issuer 540 that issued the card to the customer. For example, if the customer obtained his or her card from a bank, that bank may act as the issuer 540. The issuer 540 may perform various actions to verify that the desired transaction may be completed, including, for example, verifying that the customer identifier is valid and/or verifying that the desired purchase is within the credit or debit limit available to the customer. The issuer 540 may create an authorization message, which may, for example, approve or deny the desired transaction. The authorization message may eventually be routed back to the merchant 510, as described herein with respect to FIG. 5B.

As shown in FIG. 5B and as indicated by arrow 534, the issuer 540 may provide the authorization message to the card network 530. As indicated by arrow 524, the card network 530 may provide the authorization message, or any other authorization data, to the acquirer 520. In various exemplary embodiments, an entity may operate as both the card network 530 and card issuer 106. The acquirer 520 in that situation may route the authorization request to the combined entity and the combined entity may provide the authorization message to the acquirer 520. Also, the card network 530 itself may operate as the issuer 540, as described herein. The acquirer 520 in that situation may route the authorization request to the card network 530 and the card network 530 may provide the authorization message to the acquirer 520.

As indicated by arrow 514, the acquirer 520 may provide the authorization message, or any other authorization data, to the merchant 510. If the transaction was denied, the merchant 510 may deny the desired transaction and, for example, refuse to provide the customer with his or her desired goods or services. If the transaction was approved, the merchant 510 may complete the transaction by, for example, receiving the customer's written signature on a receipt, providing the desired goods or services to the customer, and/or storing information associated with the transaction for later settlement. For example, the merchant may store information electronically in a batch file. It is well-known in the art that electronic files may be stored in various ways, including, without limitation, a batch file, flat file, indexed file, hierarchical database, relational database, Microsoft® Excel file, Microsoft® Access file, or any other storage mechanism. As will be understood by those of ordinary skill in the art, although not described herein, if the transaction is authorized, a settlement process will occur in which the merchant 510 may receive payment for the transaction, for example, along with a plurality of other transactions executed at the merchant 510, as part of a batch.

FIG. 6 is a flow diagram illustrating an exemplary method 600 for authenticating a user by a card network in accordance with certain embodiments of the disclosed technology.

According to some embodiments, acquirer 620, card network 630 and issuer 640 shown in FIG. 6 may be configured to include some or all of the features and perform some or all of the functions described above with respect to acquirer 520, card network 530 and issuer 540, respectively, as described previously above with respect to FIGS. 5A and 5B. Further, in some embodiments, mobile device 610 shown in FIG. 6 may include some or all of the features and functions described above with respect to mobile device system 320A described with respect to FIG. 3A and/or user device 402 with respect to FIG. 4.

According to some embodiments, mobile device 610 may be configured to receive data in a Europay-Visa-Mastercard (EMV) format from a smart card, via, for example, near-field communication (NFC). In some embodiments, the mobile device 610 may have prompted the user to obtain the data from the smart card, by for example, tapping the smart card to the mobile device 610, in response to receiving a request to authenticate the user. Thus, for example, by tapping the smart card to the mobile device 610, the user may be initiating a process to perform an authentication using the payment processing infrastructure. Accordingly, in some embodiments, mobile device 610 may be configured to generate transaction data based on the received EMV data, such as for example, a zero-dollar authentication transaction. The transaction data may be in a format similar to transaction data generated by merchant 510 described above with respect to FIG. 5A, however as described previously with respect to mobile device system 320A, the transaction data generated by mobile device 610 may additionally include an authentication flag. According to some embodiments, as shown by arrow 612, mobile device 610 may be configured to communicate the transaction data to acquirer 620, as shown by arrow 622 acquirer 620 may communicate the transaction data to card network 630, and as shown by arrow 632 card network may communicate the transaction data to issuer 640 in a manner similar to the communication between merchant 510, acquirer 520, network 530 and issuer 540 described above with respect to FIGS. 5A and 5B.

However, according to some embodiments, as shown by arrows 636 and 638, mobile device 610 may also receive communications directly from card network 630 and/or network authentication 635. According to some embodiments, network authentication 635 may include some or all of the features as authentication system 320B described above with respect to FIG. 3B or system 408 described above with respect to FIG. 4. In some embodiments, network authentication 635 may be a separate device or system from card network 630 and as shown by arrow 636, may receive communications from card network card 630. Although, in some embodiments, network authentication 635 may be integrated as a part of card network 630.

As shown in FIG. 6, the card network 630 may receive the transaction data generated by the mobile device 610 via the acquirer 620. According to some embodiments, the card network 630 may include software that is configured to detect the authentication flag that is present in the transaction data. In some embodiments, in response to detecting the authentication flag in the transaction data, the card network 630 may forward the transaction data to the network authentication 635. In some embodiments, network authentication 635 may be integrated as part of card network 630, in which case the transaction data will be internally routed to the network authentication 635. In either case, upon receiving the transaction data, the network authentication 635 may compare information from the transaction data to information stored by the network authentication 635 to determine if there’s a match. For example, in some embodiments, the network authentication 635 may compare a PAN included in the transaction data (e.g., included in EMV data) to a table of stored PANs to find a match. Upon finding a match, the network authentication 635 may then lookup identity information stored in the table in association with the PAN. The identity information may include user identification information (e.g., name, address, phone number, date of birth, etc.) and/or user device identification information (e.g., phone number associated with device, international mobile equipment number (IMEI), mobile equipment identifier (MEID), MAC address, IP address, software application identifier, or any other identifier associated with the user’s mobile device). According to some embodiments, based on the device identification information, the network authentication 635 may then transmit the user identification information directly to the mobile device 610 (e.g., to a mobile application on the mobile device 610 via the Internet). Upon receiving the user identification information, the mobile device 610 may then authenticate the user by comparing the user identification information to other user identification information stored on the mobile device 610 to determine if the information matches. If the information matches, the mobile device 610 may respond to the request to authenticate the user with an indication that the user has been successfully authenticated, whereas if the information does not match, the mobile device 610 may respond to the request to authenticate the user with an indication that the user has not been successfully authenticated.

In some embodiments, instead of transmitting user identification information to the mobile device 610, the network authentication 635 may authenticate the user itself by verifying the user’s identity by verifying the authenticity of the received EMV data (e.g., an EMV cryptogram) and upon verifying the user’s identity, may instead transmit a user identity verification message to the mobile device 610, which serves to authenticate the user. For example, in some embodiments, the network authentication 635 may derive a card holder’s name and/or zip code from the EMV data and compare it to a stored card holder name and/or zip code that is stored in association with the PAN number contained in the EMV data to determine whether the received card holder name and/or zip code matches the stored card holder name and/or zip code. If the received data matches the stored data that is associated with the same PAN as the PAN contained in the received EMV data, then the network authentication 635 may verify the user’s identity. However, if the received data does not match the stored data that is associated with the same PAN as the PAN contained in the received EMV data, then the network authentication 635 may determine that the user’s identify has not been verified and may transmit a message to mobile device 610 indicating that the user was not successfully authenticated.

FIG. 7 is a flow diagram illustrating an exemplary method 700 for authenticating a user by an issuer in accordance with certain embodiments of the disclosed technology.

According to some embodiments, acquirer 720, card network 730 and issuer 740 shown in FIG. 7 may be configured to include some or all of the features and perform some or all of the functions described above with respect to acquirer 520, card network 530 and issuer 540, respectively, as described previously above with respect to FIGS. 5A and 5B. Further, in some embodiments, mobile device 710 shown in FIG. 7 may include some or all of the features and functions described above with respect to mobile device system 320A described with respect to FIG. 3A and/or user device 402 with respect to FIG. 4.

According to some embodiments, mobile device 710 may be configured to receive data in a Europay-Visa-Mastercard (EMV) format from a smart card, via, for example, near-field communication (NFC). In some embodiments, the mobile device 710 may have prompted the user to obtain the data from the smart card, by for example, tapping the smart card to the mobile device 710, in response to receiving a request to authenticate the user. Thus, for example, by tapping the smart card to the mobile device 710, the user may be initiating a process to perform an authentication using the payment processing infrastructure. Accordingly, in some embodiments, mobile device 710 may be configured to generate transaction data based on the received EMV data, such as for example, a zero-dollar authentication transaction. The transaction data may be in a format similar to transaction data generated by merchant 510 described above with respect to FIG. 5A, however as described previously with respect to mobile device system 320A, the transaction data generated by mobile device 710 may additionally include an authentication flag. According to some embodiments, as shown by arrow 712, mobile device 710 may be configured to communicate the transaction data to acquirer 720, as shown by arrow 722 acquirer 720 may communicate the transaction data to card network 730, and as shown by arrow 732 card network may communicate the transaction data to issuer 740 in a manner similar to the communication between merchant 510, acquirer 520, network 530 and issuer 540 described above with respect to FIGS. 5A and 5B.

However, according to some embodiments, as shown by arrows 746 and 748, mobile device 710 may also receive communications directly from issuer 740 and/or issuer authentication 745. According to some embodiments, issuer authentication 745 may include some or all of the features as authentication system 320B described above with respect to FIG. 3B or system 408 described above with respect to FIG. 4. In some embodiments, issuer authentication 745 may be a separate device or system from issuer 740 and as shown by arrow 746, may receive communications from issuer 740. Although, in some embodiments, issuer authentication 745 may be integrated as a part of issuer 740.

As shown in FIG. 7, the issuer 740 may receive the transaction data generated by the mobile device 710 via the acquirer 720 and the card network 730. According to some embodiments, the issuer 740 may include software that is configured to detect the authentication flag that is present in the transaction data. In some embodiments, in response to detecting the authentication flag in the transaction data, the issuer 740 may forward the transaction data to the issuer authentication 745. In some embodiments, issuer authentication 745 may be integrated as part of issuer 740, in which case the transaction data will be internally routed to the issuer authentication 745. In either case, upon receiving the transaction data, the network authentication 745 may compare information from the transaction data to information stored by the issuer authentication 745 to determine if there’s a match. For example, in some embodiments, the issuer authentication 745 may compare a PAN included in the transaction data (e.g., included in EMV data) to a table of stored PANs to find a match. Upon finding a match, the issuer authentication 745 may then lookup identity information stored in the table in association with the PAN. The identity information may include user identification information (e.g., name, address, phone number, date of birth, etc.) and/or user device identification information (e.g., phone number associated with device, international mobile equipment number (IMEI), mobile equipment identifier (MEID), MAC address, IP address, software application identifier, or any other identifier associated with the user’s mobile device). According to some embodiments, based on the device identification information, the issuer authentication 745 may then transmit the user identification information directly to the mobile device 710 (e.g., to a mobile application on the mobile device 710 via the Internet). Upon receiving the user identification information, the mobile device 710 may then authenticate the user by comparing the user identification information to other user identification information stored on the mobile device 710 to determine if the information matches. If the information matches, the mobile device 710 may respond to the request to authenticate the user with an indication that the user has been successfully authenticated, whereas if the information does not match, the mobile device 710 may respond to the request to authenticate the user with an indication that the user has not been successfully authenticated.

In some embodiments, instead of transmitting user identification information to the mobile device 610, the issuer authentication 745 may authenticate the user itself by verifying the user’s identity by verifying the authenticity of the received EMV data (e.g., an EMV cryptogram) and upon verifying the user’s identity, may instead transmit a user identity verification message to the mobile device 710, which serves to authenticate the user. For example, in some embodiments, the network authentication 635 may derive a card holder’s name and/or zip code from the EMV data and compare it to a stored card holder name and/or zip code that is stored in association with the PAN number contained in the EMV data to determine whether the received card holder name and/or zip code matches the stored card holder name and/or zip code. If the received data matches the stored data that is associated with the same PAN as the PAN contained in the received EMV data, then the issuer authentication 745 may verify the user’s identity. However, if the received data does not match the stored data that is associated with the same PAN as the PAN contained in the received EMV data, then the issuer authentication 745 may determine that the user’s identify has not been verified and may transmit a message to mobile device 610 indicating that the user was not successfully authenticated.

Although FIGS. 6 and 7 are described with respect to a user authentication being performed by the user responding to a prompt on the mobile device to tap their smart card to the mobile device, it is also contemplated that this authentication process may alternatively occur in conjunction with a transaction authorization processed by the mobile device (e.g., mobile device system 320A). For example, if the user taps their credit card to pay for a purchase made on a website using their mobile device, a software application on the mobile device, when processing the transaction information in conjunction with the purchase, may further use the received transaction information from the credit card to request for authentication. For example, in some embodiments, such a user authentication process may be launched in response to the mobile device determining that an attempted purchase amount exceeds a predetermined threshold or any other event that might trigger a user authentication process (e.g., detection of suspicious purchase activity). In some embodiments, once the user taps their smart card to the mobile device, the authentication process may proceed in a manner similar to that described above with respect to FIGS. 6 and 7 in which identity information is ultimately transmitted to the mobile device by a node of the payment processing system, allowing two processes to occur at one time, a typical transaction authorization, and an identity / authentication action. In some embodiments, the identity information may serve as an authentication that allows the transaction to proceed (e.g., the authentication having been made by the card network/issuer). In some embodiments, the mobile device may be able to interact with a merchant website or application, and the merchant website or application may be able to request an identity / authentication action in addition to the transaction authorization. In some embodiments, the identity information may received by the mobile device and compared to other user identity information obtained by the mobile device from the user, such as for example, a PIN number, biometric data (e.g., facial scan, fingerprint scan, etc.), a password, a zip code, or other identifying information of the user.

Further, although FIGS. 6 and 7 are described with respect to a user authentication being performed by the user responding to a prompt on the mobile device to tap their smart card to the mobile device, it is also contemplated that in alternate embodiments, a user authentication may be performed in response to a user tapping their smart card to a merchant POS device in response to a prompt presented by the merchant POS device. For example, upon checking out at a merchant POS device, the merchant POS device may present a prompt to the user to tap their smart card to a reader of the merchant POS device to authenticate the user and the merchant POS device may generate and include an authentication flag in the transaction data sent to the card network/issuer, which may then perform an authentication of the user in a manner similar to that described above with respect to FIGS. 6 and 7. In some embodiments, the merchant POS device may include additional data that can be passed along the payment processing infrastructure and/or the merchant POS may include another connection or rail to receive additional information.

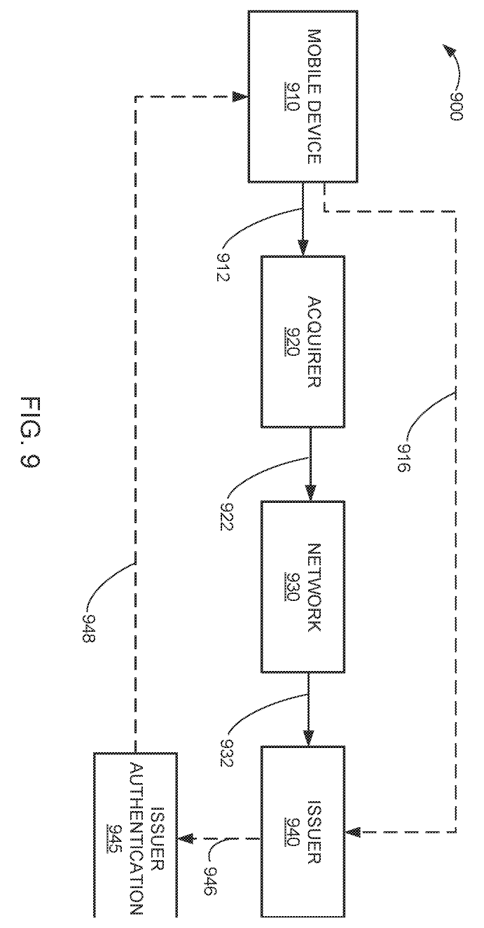

FIG. 8 is a flow diagram illustrating an exemplary method 800 for authenticating a user by a card network in accordance with certain embodiments of the disclosed technology.

According to some embodiments, acquirer 820, card network 830 and issuer 840 shown in FIG. 8 may be configured to include some or all of the features and perform some or all of the functions described above with respect to acquirer 520, card network 530 and issuer 540, respectively, as described previously above with respect to FIGS. 5A and 5B. Further, in some embodiments, mobile device 810 shown in FIG. 8 may include some or all of the features and functions described above with respect to mobile device system 320A described with respect to FIG. 3A and/or user device 402 with respect to FIG. 4.

According to some embodiments, mobile device 810 may be configured to receive data in a Europay-Visa-Mastercard (EMV) format from a smart card, via, for example, near-field communication (NFC). In some embodiments, the mobile device 810 may have prompted the user to obtain the data from the smart card, by for example, tapping the smart card to the mobile device 810, in response to, for example, the user making a purchase via a mobile application installed on the mobile device 810 and/or receiving a request to authenticate the user. Thus, for example, by tapping the smart card to the mobile device 810, the user may be simultaneously initiating a first process to execute a purchase transaction using the payment processing infrastructure and a second process to perform an authentication of the user based on the data received from the smart card.

In some embodiments, the mobile device 810 may be configured to generate transaction data based on the received EMV data, such as for example, transaction data for a purchase made at an online merchant using the smart card. The transaction data may be in a format similar to transaction data generated by merchant 510 described above with respect to FIG. 5A. According to some embodiments, as shown by arrow 812, mobile device 810 may be configured to communicate the transaction data to acquirer 820, as shown by arrow 822 acquirer 820 may communicate the transaction data to card network 830, and as shown by arrow 832 card network may communicate the transaction data to issuer 840 in a manner similar to the communication between merchant 510, acquirer 520, network 530 and issuer 540 described above with respect to FIGS. 5A and 5B. Although not depicted in FIG. 8, the transaction data sent to issuer 840 for the purchase transaction may include a transaction authorization request and the issuer may return a response to the request in a manner similar to that described previously with respect to FIG. 5B.

Separately, according to some embodiments, as shown by arrow 816, the mobile device 810 may be configured to transmit data obtained from the smart card (e.g., EMV data) directly to the card network 830, which then may perform an authentication process using network authentication 835 in a manner similar to that described previously above with respect to network authentication 635 shown in FIG. 6 and as shown by arrows 836 and 838 may communicate identity information to authenticate the user to the mobile device 810. According to some embodiments, software on the mobile device 810 (e.g., a mobile application, browser extension, etc.) may be configured to communicate smart card data directly to the card network 830 via a network by for example, the software having been prepopulated with one or more internet protocol (IP) addresses or other such identifiers associated with the card network 830.

FIG. 9 is a flow diagram illustrating an exemplary method 900 for authenticating a user by an issuer in accordance with certain embodiments of the disclosed technology.

According to some embodiments, acquirer 920, card network 930 and issuer 940 shown in FIG. 9 may be configured to include some or all of the features and perform some or all of the functions described above with respect to acquirer 520, card network 530 and issuer 540, respectively, as described previously above with respect to FIGS. 5A and 5B. Further, in some embodiments, mobile device 910 shown in FIG. 9 may include some or all of the features and functions described above with respect to mobile device system 320A described with respect to FIG. 3A and/or user device 402 with respect to FIG. 4.

According to some embodiments, mobile device 910 may be configured to receive data in a Europay-Visa-Mastercard (EMV) format from a smart card, via, for example, near-field communication (NFC). In some embodiments, the mobile device 910 may have prompted the user to obtain the data from the smart card, by for example, tapping the smart card to the mobile device 910, in response to, for example, the user making a purchase via a mobile application installed on the mobile device 910 and/or receiving a request to authenticate the user. Thus, for example, by tapping the smart card to the mobile device 910, the user may be simultaneously initiating a first process to execute a purchase transaction using the payment processing infrastructure and a second process to perform an authentication of the user based on the data received from the smart card.

In some embodiments, the mobile device 910 may be configured to generate transaction data based on the received EMV data, such as for example, transaction data for a purchase made at an online merchant using the smart card. The transaction data may be in a format similar to transaction data generated by merchant 510 described above with respect to FIG. 5A. According to some embodiments, as shown by arrow 912, mobile device 910 may be configured to communicate the transaction data to acquirer 920, as shown by arrow 922 acquirer 920 may communicate the transaction data to card network 930, and as shown by arrow 932 card network may communicate the transaction data to issuer 940 in a manner similar to the communication between merchant 510, acquirer 520, network 530 and issuer 540 described above with respect to FIGS. 5A and 5B. Although not depicted in FIG. 9, the transaction data sent to issuer 940 for the purchase transaction may include a transaction authorization request and the issuer may return a response to the request in a manner similar to that described previously with respect to FIG. 5B.

Separately, according to some embodiments, as shown by arrow 916, the mobile device 910 may be configured to transmit data obtained from the smart card (e.g., EMV data) directly to the issuer 940, which then may perform an authentication process using issuer authentication 945 in a manner similar to that described previously above with respect to issuer authentication 745 shown in FIG. 7 and as shown by arrows 946 and 948 may communicate identity information to authenticate the user to the mobile device 910. According to some embodiments, software on the mobile device 910 (e.g., a mobile application, browser extension, etc.) may be configured to communicate smart card data directly to the issuer 940 via a network by for example, the software having been prepopulated with one or more internet protocol (IP) addresses or other such identifiers associated with the issuer 940.

Although the preceding description describes various functions of a mobile device system 320A, an authentication system 320B, a user device 402, a web server 410, and a database 416, in some embodiments, some or all of these functions may be carried out by a single computing device.

### EXAMPLE USE CASE

The following example use case describes an example of a typical user flow pattern. This section is intended solely for explanatory purposes and not in limitation.

In one example, a user may want to access a secure portion of their banking application using a mobile device (e.g., via mobile device system 320A) that requires multi-factor authentication. Accordingly, after providing first credentials (a username and password), the mobile application may then prompt the user to tap the smart card to the mobile device such that the smart card may convey smart card data (e.g., EMV data) to the mobile application on the mobile device via, for example, near-field communication. The smart card data may include information about an account of the user, such as a PAN number. The mobile application may then generate a $0.00 transaction using the provided PAN number and modify the transaction to include an authentication flag by, for example, providing the flag in an unused field of the transaction data (e.g., modifying a default value of an unused field from “0” to “1”) or by adding a prefix to some portion of the data (e.g., adding “***” to the beginning of the merchant name). The mobile application may then submit the modified transaction data to a payment processing infrastructure, which would typically include for example, transmitting the modified transaction data to an acquirer (e.g., acquirer 620), which may then transmit the modified transaction data to a card network (e.g., card network 630), which may then ultimately transmit the modified transaction data to an issuer (e.g., issuer 640) to process a transaction authorization request associated with the modified transaction data. Upon receiving the modified transaction data, a node of the payment processing infrastructure (e.g., the card network or issuer) may be configured to detect the presence of the authentication flag in the modified transaction data, which may trigger an authentication process in which the node may forwards the modified transaction data to an authentication system (e.g., authentication system 320B), which may be internal or external to the node. In some cases, when the node detects the presence of the authentication flag (e.g., paired with the “$0.00” transaction value), the node may determine that the modified transaction data does not represent an actual purchase transaction but only represents a request to authenticate the user using the smart card, and therefore may terminate the typical process of seeking a transaction authorization (e.g., the card network will not forward the modified transaction data to the issuer in this case). The authentication system may include a table or database correlating account information to user information. For example, the authentication system may include a table of PANs and the user/cardholder information associated with each PAN, which may also include device information of one or more devices associated with the user. The authentication system may identify a PAN included in the modified transaction data and perform a lookup in the table to identity user identity information (e.g., full name of user) and device information (e.g., a device identifier, a phone number, etc.) sufficient to allow the authentication system to verify the user identity information associated with the PAN and communicate the verification to the user’s mobile device (e.g., via the Internet). Upon receiving the verification of the user identity from the authentication system, the mobile device may authenticate the user and provide the authentication to the mobile application to allow the user access to the secure portion of the banking application.

In another example, the user may be making a purchase using a mobile application (or browser having a specialized browser extension) of a mobile device (e.g., mobile device system 320A) that requires a user authentication, however, the disclosed system may perform the user authentication simultaneously with the attempted purchase. In other words, in this case, instead of receiving a prompt to tap their smart card to the mobile device for multi-factor authentication, the user may be prompted to tap their smart card to their mobile device to make the desired purchase. The mobile application may generate transaction data, including placing an authentication flag in the transaction data, however instead the transaction data being for a “$0.00” transaction, the transaction data will reflect the details of the purchase being attempted by the user. The mobile device may transmit the transaction data to the payment processing system (e.g., may transmit the transaction data to the acquirer) and a node (e.g., the card network) of the payment processing system may detect the authentication flag and perform the authentication of the user in a manner similar to that described above in the previous example. However, in this case the card network will forward the transaction data to the issuer as well, which may then approve or deny the transaction authorization request in a conventional fashion and relay the approval/denial back to the acquirer for processing. Thus, in this case, the user authentication and transaction approval may occur approximately simultaneously based on a single tap of the smart card to the user’s mobile device.

In yet another example, the mobile device (e.g., mobile device system 320A) may communicate smart card data (e.g., EMV data) directly to a node of the payment processing infrastructure that performs the authentication function. In other words, instead of submitting transaction data to an acquirer that is forwarded to a card network that is then forwarded to an issuer, the mobile device may directly transmit smart card data to a card network or to an issuer. Thus, for example, a user may be utilizing a mobile application while making a purchase with their mobile device and upon attempting to make a purchase the mobile application may prompt the user to tap their smart card to the mobile device to perform a user authentication. Upon tapping their smart card to the mobile device, the mobile device may acquire the smart card data (e.g., EMV data) and forward that data directly to, for example, a card network. For example, the mobile application on the mobile device may store destination information (e.g., IP addresses, website addresses, etc.) of the card network that is designated as a location for receiving the smart card data from the mobile device to perform the authentication. Thus, for example, in response to receiving an authentication request from the mobile application, the user may tap their smart card to the mobile device, the mobile device may acquire EMV data from the smart card and forward the EMV data to the card network, which may then identify a PAN in the EMV data and perform a look up of the user identity information associated with the PAN, verify the user identity information associated with the PAN and transmit the verification back to the mobile application on the mobile device to complete the authentication process. Although this example was described with respect to the card network performing the lookup/authentication functions, it is also contemplated that these functions may be alternatively performed by the issuer or other entity.

In some examples, disclosed systems or methods may involve one or more of the following clauses:

Clause 1: A method for authenticating a user, the method comprising: receiving, first information at a card network from a mobile device, wherein the mobile device received the first information from a smart card; determining, at the card network, that the first information comprises an authentication flag; authenticating, by the card network, an identity of the user by comparing the first information to second information associated with the user and stored in a database; and transmitting, from the card network, identity information associated with the first information to the mobile device.

Clause 2: The method of Clause 1, wherein: the mobile device receives the first information from the smart card via near field communication (NFC), the first information is in a Europay-Visa-Mastercard (EMV) format, and the first information is generated by an EMV applet on the smart card.

Clause 3: The method of Clause 1, wherein: the first information is transmitted to the card network from the mobile device via an acquirer, and the acquirer determines the card network from a plurality of card networks.

Clause 4: The method of Clause 3, wherein the identity information is not transmitted to the mobile device via the acquirer.

Clause 5: The method of Clause 1, wherein the identity information is transmitted from the card network to the mobile device directly.

Clause 6: The method of Clause 1, wherein the authentication flag prevents the first information from being transmitted to an issuer.

Clause 7: The method of Clause 1, wherein the first information is a zero-amount authorization.

Clause 8: The method of Clause 1, wherein the authentication flag is a name, name prefix, name suffix, or combinations thereof.

Clause 9: The method of Clause 1, wherein the second information associated with the user comprises communication information, and the card network transmits the identity information to a mobile application on the mobile device using the communication information.

Clause 10: A method for authenticating a user, the method comprising: receiving, at a mobile device, from a smart card via near field communication (NFC), first data, the first data in a Europay-Visa-Mastercard (EMV) format; generating, from the first data, second data comprising an authentication flag, the authentication flag indicating a request for authentication; transmitting the second data to a card network; and receiving, from the card network, identity information to authenticate the user.

Clause 11: The method of Clause 10, further comprising: receiving, from the user, via a first graphical user interface on a mobile application on the mobile device, an action requiring authentication; generating, at the mobile device, a second graphical user interface, requesting the user locate the smart card near the mobile device; and displaying the second graphical user interface on a display of the mobile device.

Clause 12: The method of Clause 11, further comprising: responsive to receiving the identity information from the card network to authenticate the user, generating, at the mobile device, a third graphical user interface showing that the user is authenticated; and displaying the third graphical user interface on the display of the mobile device.

Clause 13: The method of Clause 10, wherein: the first data is generated by an EMV applet on the smart card.

Clause 14: The method of Clause 10, wherein: the second data is transmitted to the card network via an acquirer, and the acquirer determines the card network from a plurality of card networks.

Clause 15: The method of Clause 14, wherein the identity information is not received from the card network via an acquirer.

Clause 16: The method of Clause 12, wherein the identity information is transmitted from the card network to the mobile device directly.

Clause 17: A method for authenticating a user, the method comprising: receiving, first information from a mobile device, wherein the mobile device received the first information from a smart card; determining that the first information comprises an authentication flag; authenticating an identity of the user by comparing the first information to second information associated with the user and stored in a database; and transmitting identity information associated with the first information to the mobile device.

Clause 18: The method of Clause 17, wherein: the mobile device receives the first information from the smart card via near field communication (NFC), the first information is in a Europay-Visa-Mastercard (EMV) format, and the first information is generated by an EMV applet on the smart card.

Clause 19: The method of Clause 17, wherein: the first information is received via an acquirer and a card network.

Clause 20: The method of Clause 17, wherein the identity information is transmitted to the mobile device directly.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for authenticating a user, the method comprising:
receiving, first information at a card network from a mobile device, wherein the mobile device received the first information from a smart card;
determining, at the card network, that the first information comprises an authentication flag;
authenticating, by the card network, an identity of the user by comparing the first information to second information associated with the user and stored in a database; and
transmitting, from the card network, identity information associated with the first information to the mobile device.

2. The method of claim 1, wherein:
the mobile device receives the first information from the smart card via near field communication (NFC),
the first information is in a Europay-Visa-Mastercard (EMV) format, and
the first information is generated by an EMV applet on the smart card.

3. The method of claim 1, wherein:
the first information is transmitted to the card network from the mobile device via an acquirer, and
the acquirer determines the card network from a plurality of card networks.

4. The method of claim 3, wherein the identity information is not transmitted to the mobile device via the acquirer.

5. The method of claim 1, wherein the identity information is transmitted from the card network to the mobile device directly.

6. The method of claim 1, wherein the authentication flag prevents the first information from being transmitted to an issuer.

7. The method of claim 1, wherein the first information is a zero-amount authorization.

8. The method of claim 1, wherein the authentication flag is a name, name prefix, name suffix, or combinations thereof.

9. The method of claim 1, wherein the second information associated with the user comprises communication information, and
the card network transmits the identity information to a mobile application on the mobile device using the communication information.

10. A method for authenticating a user, the method comprising:
receiving, at a mobile device, from a smart card via near field communication (NFC), first data, the first data in a Europay-Visa-Mastercard (EMV) format;
generating, from the first data, second data comprising an authentication flag, the authentication flag indicating a request for authentication;
transmitting the second data to a card network; and
receiving, from the card network, identity information to authenticate the user.

11. The method of claim 10, further comprising:
receiving, from the user, via a first graphical user interface on a mobile application on the mobile device, an action requiring authentication;
generating, at the mobile device, a second graphical user interface, requesting the user locate the smart card near the mobile device; and
displaying the second graphical user interface on a display of the mobile device.

12. The method of claim 11, further comprising:
responsive to receiving the identity information from the card network to authenticate the user, generating, at the mobile device, a third graphical user interface showing that the user is authenticated; and
displaying the third graphical user interface on the display of the mobile device.

13. The method of claim 10, wherein:
the first data is generated by an EMV applet on the smart card.

14. The method of claim 10, wherein:
the second data is transmitted to the card network via an acquirer, and
the acquirer determines the card network from a plurality of card networks.

15. The method of claim 14, wherein the identity information is not received from the card network via an acquirer.

16. The method of claim 12, wherein the identity information is transmitted from the card network to the mobile device directly.

17. A method for authenticating a user, the method comprising:
receiving, first information from a mobile device, wherein the mobile device received the first information from a smart card;
determining that the first information comprises an authentication flag;
authenticating an identity of the user by comparing the first information to second information associated with the user and stored in a database; and
transmitting identity information associated with the first information to the mobile device.

18. The method of claim 17, wherein:
the mobile device receives the first information from the smart card via near field communication (NFC),
the first information is in a Europay-Visa-Mastercard (EMV) format, and
the first information is generated by an EMV applet on the smart card.

19. The method of claim 17, wherein:
the first information is received via an acquirer and a card network.

20. The method of claim 17, wherein the identity information is transmitted to the mobile device directly.
